(19) United States
(12) Patent Application Publication
(10) Pub. No.: US 2026/0310583 A1
(43) Pub. Date: Oct. 8, 2026

(54) SYSTEMS AND METHODS FOR REMEDIATING FAILURES IN EXECUTING SOFTWARE CODE USING CODE-FAILURE TAXONOMY

(71) Applicants: Constructor Technology AG, Schaffhausen (CH); Constructor Education and Research Genossenschaft, Schaffhausen (CH); Constructor Labs gGmbH, Bremen (DE)

(72) Inventors: Alexander Tormasov, Busingen am Hochrhein (DE); Giancarlo Succi, Genova (IT); Nikolay Dobrovolskiy, Alanya (TR); Stanislav Protasov, Singapore (SG); Laurent Dedenis, Geneve (CH); Serg Bell, Singapore (SG)

(21) Appl. No.: 19/715,572

(22) Filed: Jun. 22, 2026

Related U.S. Application Data
(63) Continuation-in-part of application No. 19/003,889, filed on Dec. 27, 2024.

(51) Int. Cl. G06F 11/3668; G06F 9/48

(52) U.S. Cl. CPC G06F 11/3672; G06F 9/4843

(57) ABSTRACT

Disclosed are systems and methods for remediating failures in executing software code associated with a scientific or technical document using a code-failure taxonomy. An example method includes: retrieving a scientific or technical document and associated software code configured to programmatically implement scientific or technical computational procedures described within the document; generating a feature descriptor identifying one or more scientific or technical features of the document and one or more corresponding code features of the software code; executing the software code, detecting a code execution failure, and generating a failure signature comprising a descriptor of the failure; identifying, based on the feature descriptor, a failure classification node in the code-failure taxonomy, wherein each failure classification node contains at least one failure signature and a corresponding remediation strategy specifying one or more corrective actions; and when the failure signature matches the at least one failure signature, performing the corresponding corrective actions.

### RELATED APPLICATIONS

The present disclosure is a continuation-in-part of U.S. patent application Ser. No. 19/003,889, filed on Dec. 27, 2024, the entire disclosure of which is incorporated herein by reference.

### FIELD OF TECHNOLOGY

The present disclosure relates generally to systems and methods for executing, testing, and repairing software code associated with scientific or technical documents. More specifically, the disclosure relates to systems and methods for remediating failures in executing such software code using a code-failure taxonomy.

### BACKGROUND

Scientific and technical research increasingly relies on software code to implement, validate, and reproduce the computational procedures described in published documents such as journal articles, conference papers, technical reports, and preprints. A typical research publication may describe algorithms, experimental parameters, and expected results, while an associated code repository contains the executable implementation of those procedures. Together, the document and its associated code form a document-code pair that represents a complete computational research project.

Despite the growing importance of computational reproducibility, executing software code associated with scientific and technical documents remains a significant challenge. The software code is frequently developed in a specific computing environment with particular operating system configurations, library versions, hardware resources, and runtime dependencies. When other researchers, reviewers, or automated systems attempt to execute the same code in a different environment, failures are common. These failures range from missing software dependencies and version incompatibilities to incorrect parameter configurations, deprecated function calls, and hardware resource mismatches. Even when the code executes without raising explicit errors, the results may diverge from those reported in the associated document due to subtle differences in execution conditions, data preprocessing steps, or numerical precision.

Related approaches to addressing these challenges have significant limitations. Package managers and dependency resolution tools can install required libraries, but they do not address version conflicts, deprecated APIs, or code-level bugs. Continuous integration and continuous deployment pipelines can automate testing, but they are typically designed for software engineering projects rather than scientific code, and they do not account for the relationship between the code and the scientific document that describes its intended behavior. Containerization technologies such as Docker can capture a specific execution environment, but they require the original authors to create and maintain container images, which many researchers do not do. Automated program repair techniques can generate patches for buggy code, but they generally operate on isolated code defects without understanding the scientific context in which the code operates.

Furthermore, these related approaches typically address failures on a case-by-case basis. Each time a new code repository fails to execute, the diagnosis and repair process begins from scratch, without leveraging knowledge gained from resolving similar failures in prior projects. There is no systematic mechanism for accumulating, organizing, and reusing failure-resolution knowledge across a large and growing corpus of scientific document-code pairs.

### SUMMARY

To address the execution failures and repair the software code associated with the scientific or technical documents in structured, scalable, and knowledge-accumulating manner, this disclosure provides a taxonomy-based framework. Such a framework can improve the reproducibility and reliability of scientific content described in the documents by benefiting from two operational stages.

In a first stage, referred to herein as the preparation stage, the framework may process a large number of historical scientific or technical documents and their associated software code. For each document-code pair, the framework may analyze both the document and the code using machine learning models to extract features such as the scientific domain, algorithms, parameters, programming language, frameworks, and environment requirements. The code may be executed in a secure virtual environment, and any execution failures may be detected and characterized. For each failure, the framework may extract a failure signature and determine one or more remediation strategies, which may include modifications to the secure virtual environment, modifications to the software code, or both. The framework may apply each remediation strategy, re-execute the code, and record whether the failure is resolved or improved. From this accumulated historical execution and repair data, the framework may construct a hierarchical taxonomy in which each taxonomy node (or failure classification node) is associated with feature descriptors (or project feature descriptions), known failure signatures, proven remediation strategies, and optionally predefined test suites. The framework may also maintain coverage information for the taxonomy, identifying under-represented or untested regions where additional historical data is needed.

In a second stage, referred to herein as the inference stage, the framework may use the pre-built taxonomy to execute and repair software code associated with a new scientific or technical document. The new document and code may be analyzed using machine learning models to generate a feature descriptor (or a project feature description), which may then be used to classify the new document-code pair into one or more taxonomy nodes of the taxonomy. The framework may provision a secure virtual environment based on the environment information associated with the selected taxonomy nodes, execute the code under node-specific test suites, and detect any failures. When a failure occurs, the framework may extract a failure signature and compare it against the known failure signatures stored in the selected taxonomy nodes. If a match is found, the corresponding remediation strategy may be applied and the code may be re-executed to verify that the failure is resolved. When a new failure does not match any known failure signature, the framework may optionally add the new failure and its resolution as a new node or sub-node in the taxonomy, ensuring that the taxonomy continues to grow and improve over time.

One exemplary aspect of this disclosure provides a computer-implemented method for remediating failures in executing software code associated with a scientific or technical document using a code-failure taxonomy. The computer-implemented method includes: retrieving a scientific or technical textual document and associated software code configured to programmatically implement scientific or technical computational procedures described within the textual document; generating a feature descriptor identifying one or more scientific or technical features of the textual document and one or more corresponding code features of the software code; executing the software code, detecting a code execution failure, and generating a failure signature comprising a descriptor of the detected execution failure; identifying, based on the feature descriptor, a failure classification node in the code-failure taxonomy, wherein each node of the code-failure taxonomy contains at least one failure signature and a corresponding remediation strategy specifying one or more corrective actions; and in response to the failure signature of the software code matching the at least one failure signature contained in the identified failure classification node, performing the corresponding corrective actions.

In an aspect, each node of the code-failure taxonomy is associated with at least one environment requirement used during execution of at least one software code, wherein the at least one environment requirement includes at least one of a base operating system, a key library, or a hardware constraint.

In an aspect, each node of the code-failure taxonomy is associated with at least one test suite used during execution of at least one software code, wherein the at least one test suite includes at least one of an environment test configured to verify a software dependency in a secure virtual environment or a code execution test configured to execute a portion of the at least one software code with a test dataset.

In an aspect, the generating the feature descriptor includes: using a trained machine learning model (MLM) to identify the one or more scientific or technical features of the textual document corresponding to the scientific or technical computational procedures described within the textual document; using the trained MLM to identify in the software code the one or more code features corresponding to the identified one or more scientific or technical features of the textual document; and generating the feature descriptor combining the one or more scientific or technical features and corresponding code features.

In an aspect, the one or more scientific or technical features of the textual document include at least one of a scientific or technical domain of the textual document, a computational algorithm, a scientific procedure, a mathematical formular, a chemical formular, or a data structure containing scientific or technical data.

In an aspect, the one or more code features of the software code includes at least one of a programming language of the software code, an algorithm of the software code, a parameter or a variable of the software code, a configuration option of the software code, or a hardware requirement of the software code.

In an aspect, the identifying the failure classification node includes: inputting the feature descriptor of the textual document into a classifier MLM trained to map a plurality of feature descriptors to a plurality of failure classification nodes of the code failure taxonomy; receiving, from the classifier MLM, one or more node identifiers each associated with a respective confidence value; and identifying the failure classification node from one or more failure classification nodes associated with the one or more node identifiers based on the confidence value of the identified failure classification node exceeding a threshold.

In an aspect, the executing the software code includes: generating a secure virtual environment based on an environment requirement associated with the identified failure classification node; obtaining a test suite associated with the identified failure classification node; and executing the software code in the secure virtual environment under the test suite to obtain the code execution failure.

In an aspect, the computer-implemented method further includes: after the performing the corresponding corrective actions, re-executing the software code in the secure virtual environment under the test suite to determine whether the software code executes correctly; and in response to the software code executing correctly, reporting the corresponding remediation strategy contained in the identified failure classification node.

In an aspect, the computer-implemented method further includes: in response to the software code not executing correctly or the failure signature of the software code not matching the at least one failure signature contained in the identified failure classification node, applying a generic or heuristic remediation strategy to the software code; generating a new failure classification node of the code-failure taxonomy; and associating with the new failure classification node the failure signature of the software code and a corresponding remediation strategy.

In an aspect, the code execution failure includes at least one of log data, an error message, a stack trace, or an output mismatch indicating a discrepancy with one or more of the scientific or technical computational procedures described within the textual document.

In an aspect, the failure signature is based on a normalized representation of the at least one of the log data, the error message, the stack trace, or the output mismatch included in the code execution failure.

In an aspect, the remediation strategy includes at least one of an environment-level modification or a code-level modification to the software code.

In an aspect, the environment-level modification includes a modification to at least one of a software dependency, a library version, an environment variable, or a hardware allocation.

In an aspect, the code-level modification includes at least one of an application of a predefined path template or a change of the software code using an MLM.

In an aspect, a hierarchical structure of the code-failure taxonomy includes a multi-level taxonomy tree with each level representing a failure granularity of the code execution failure.

One exemplary aspect of the disclosure provides a system for remediating failures in executing software code associated with a scientific or technical document using a code-failure taxonomy. The system includes processing circuitry configured to: retrieve a scientific or technical textual document and associated software code configured to programmatically implement scientific or technical computational procedures described within the textual document; generate a feature descriptor identifying one or more scientific or technical features of the textual document and one or more corresponding code features of the software code; execute the software code, detect a code execution failure, and generate a failure signature comprising a descriptor of the detected execution failure; identify, based on the feature descriptor, a failure classification node in the code-failure taxonomy, wherein each node of the code-failure taxonomy contains at least one failure signature and a corresponding remediation strategy specifying one or more corrective actions; and in response to the failure signature of the software code matching the at least one failure signature associated with the identified failure classification node, perform the corresponding corrective actions.

One exemplary aspect of this disclosure provides a non-transitory computer readable medium storing thereon computer executable instructions for remediating failures in executing software code associated with a scientific or technical document using a code-failure taxonomy, including instructions for: retrieving a scientific or technical textual document and associated software code configured to programmatically implement scientific or technical computational procedures described within the textual document; generating a feature descriptor identifying one or more scientific or technical features of the textual document and one or more corresponding code features of the software code; executing the software code, detecting a code execution failure, and generating a failure signature comprising a descriptor of the detected execution failure; identifying, based on the feature descriptor, a failure classification node in the code-failure taxonomy, wherein each node of the code-failure taxonomy contains at least one failure signature and a corresponding remediation strategy specifying one or more corrective actions; and in response to the failure signature of the software code matching the at least one failure signature associated with the identified failure classification node, performing the corresponding corrective actions.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for analyzing scientific or technical documents and associated software code using machine learning according to aspects of the present disclosure.

FIG. 2 is a block diagram illustrating a system for training machine learning models to identifying logic, algorithms, and/or parameters of scientific or technical documents and associated software code according to aspects of the present disclosure.

FIG. 3 is a first flow diagram of a method for machine learning (ML)-based analysis of scientific or technical documents and associated software code according to aspects of the present disclosure.

FIG. 4 is a second flow diagram of a method for machine learning (ML)-based analysis of scientific or technical documents and associated software code according to aspects of the present disclosure.

FIG. 5A is a block diagram illustrating a taxonomy generation system for generating a code-failure taxonomy for remediating failures in executing software code according to an aspect of the disclosure.

FIG. 5B shows an example of a feature extraction module of the taxonomy generation system according to an aspect of the disclosure.

FIG. 5C shows another example of a feature extraction module of the taxonomy generation system according to an aspect of the disclosure.

FIG. 5D shows a flowchart of a method for detecting an execution failure of executing software code and resolving the execution failure.

FIG. 5E shows an example of a code-failure taxonomy according to an aspect of the disclosure.

FIG. 6A shows a flowchart of a method for updating a code-failure taxonomy according to an aspect of the disclosure.

FIG. 6B shows an example of a taxonomy tree of a code-failure taxonomy illustrating a hierarchical classification of software failures for scientific or technical code execution according to an aspect of the disclosure.

FIG. 7 shows a flowchart of a method for generating a code-failure taxonomy for remediating failures in executing software code according to an aspect of the disclosure.

FIG. 8A is a block diagram illustrating a code remediation system for remediating failures in executing software code associated with a scientific or technical document using a code-failure taxonomy according to an aspect of the disclosure.

FIG. 8B shows an example of an environment generation module of the code remediation system according to an aspect of the disclosure.

FIG. 9 shows a flowchart of a method for remediating failures in executing software code associated with a scientific or technical document using a code-failure taxonomy according to an aspect of the disclosure.

FIG. 10 presents an example of a general-purpose computer system on which aspects of the present disclosure can be implemented.

Like reference numbers and designations in the various drawings indicate like elements.

### DETAILED DESCRIPTION

Exemplary aspects are described herein in the context of a system, method, and computer program product for machine learning (ML)-based execution of software code from scientific or technical documents in a secure computing environment. Those of ordinary skill in the art will realize that the following description is illustrative only and is not intended to be in any way limiting. Other aspects will readily suggest themselves to those skilled in art having the benefit of this disclosure. Reference will now be made in detail to implementations of the example aspects as illustrated in the accompanying drawings. The same reference indicators will be used to the extent possible throughout the drawings and the following description to refer to the same or like items.

The present disclosure describes various aspects of machine learning (ML)-based execution of software code from scientific or technical documents in a secure computing environment. One aspect involves using machine learning to analyze a scientific or technical document to identify subject matter, parameters, and/or logic of the scientific or technical document. A second aspect involves using machine learning to analyze software code associated with the scientific or technical document to identify the subject matter, parameters, and/or logic of the software code. A third aspect involves using machine learning to use a text interpretation large language model (LLM) to identify different subjects, parameters, and/or logic using one or more other scientific or technical documents from a database. A fourth aspect involves using a machine learning model to assess whether the software code corresponds to the scientific or technical documents and generating text explaining results of the comparison using an LLM.

A scientific or technical document may have software code associated with it for several reasons, depending on the nature of the research and its field. A fundamental principle of scientific research is reproducibility, which requires that other researchers can replicate the results presented in a study. Sharing computer code fosters transparency, allowing others to verify the findings or expand upon the research. In many scientific and engineering disciplines, researchers may use complex models and simulations that are developed as part of the study. Providing the software code also ensures that other researchers can run these simulations under similar conditions to understand the models better, validate the results, or test them against different datasets. In addition, many scientific or technical documents may involve the analysis of large datasets. Computer code may be provided to show how data was processed, analyzed, or visualized. Furthermore, code associated with scientific or technical documents provides a reference for how the authors implemented a particular algorithm or method. This is particularly important in cases where the method's details may be too complex to describe fully in text, or where small differences in implementation might significantly affect the results. It should be noted that the invention is not limited to scientific or technical documents, but includes any type of research paper, or the like.

However, validating software code associated with scientific or technical documents presents several challenges.

First, the manual setup of computing environments is time-consuming and prone to user errors, especially when a researcher (who may not have a technical background or experience in computer programming) needs to identify and install the correct tools, libraries, and dependencies. Automation streamlines this process, allowing researchers to focus on the core scientific tasks instead of setting up and configuring the computing environment. By automating the setup and implementation of computing environments, the researcher may easily and reliably recreate computing environments. In this way, collaboration and sharing of results may be accelerated, ensuring that the research described in the scientific or technical documents can be easily replicated by others.

Second, automation guarantees that the same environment is set up consistently, reducing variability between experimental runs due to mismatched software versions or configuration errors. Automated setup systems can ensure that all experiments adhere to certain standards or protocols, increasing the scientific rigor of the research. Software code may be written in a specific environment (e.g., specific operating systems, libraries, or versions of dependencies), and without detailed documentation. Variations in hardware or software configurations may lead to inconsistent results.

Third, leveraging AI to select and configure the necessary tools ensures that only the essential resources are deployed, optimizing computational resources and reducing waste. For example, AI can determine the best cloud instances, hardware accelerators (GPUs or TPUs), or storage solutions for specific tasks. AI may dynamically adjust the computational resources or parameters based on project requirements or ongoing experimental needs, improving the efficiency of high-performing computing environments.

Fourth, modern research, particularly in fields like genomics, astrophysics, and Al, often involves large-scale datasets and complex computational workflows. Al-driven automation can streamline and orchestrate these workflows, ensuring that all dependencies are met and the correct parameters are applied to each stage of the analysis. As machine learning and AI become central to many fields, automated setups can ensure that the necessary machine learning frameworks (e.g., TensorFlow, PyTorch) and libraries (e.g., SciPy, Pandas) are correctly configured, reducing the burden on researchers unfamiliar with these tools.

Finally, manual setup is prone to mistakes, such as missing dependencies, wrong library versions, or misconfigured environments. Automating the setup, especially with Al's ability to intelligently manage configurations, reduces the likelihood of such errors, improving the reliability of experiments. AI systems can also detect misconfigurations or performance bottlenecks during setup, offering suggestions or making automatic adjustments to optimize the environment.

Automating the setup of computing environments for scientific research, especially when combined with AI for tool selection and parameter management, enables faster, more reliable, and more scalable research. It enhances reproducibility, optimizes resource usage, facilitates collaboration, and ensures that experiments are conducted in well-tuned, error-free environments. This kind of automation is increasingly essential in modern scientific inquiry, where complexity, data, and computational demands continue to grow exponentially.

It should be noted that the present disclosure describes utilizing a computing environment for analyzing research projects based on scientific articles for illustrative purposes only and that the methods and systems described in the present disclosure may be applicable to any activity that involves comparing logic, parameters, and/or algorithms between an academic paper and computer code. As a non-limiting example, the methods and systems described in the present disclosure may be applicable to business papers and computer code.

Turning now to the figures, example aspects are depicted with reference to one or more components described herein, where components in dashed lines may be optional.

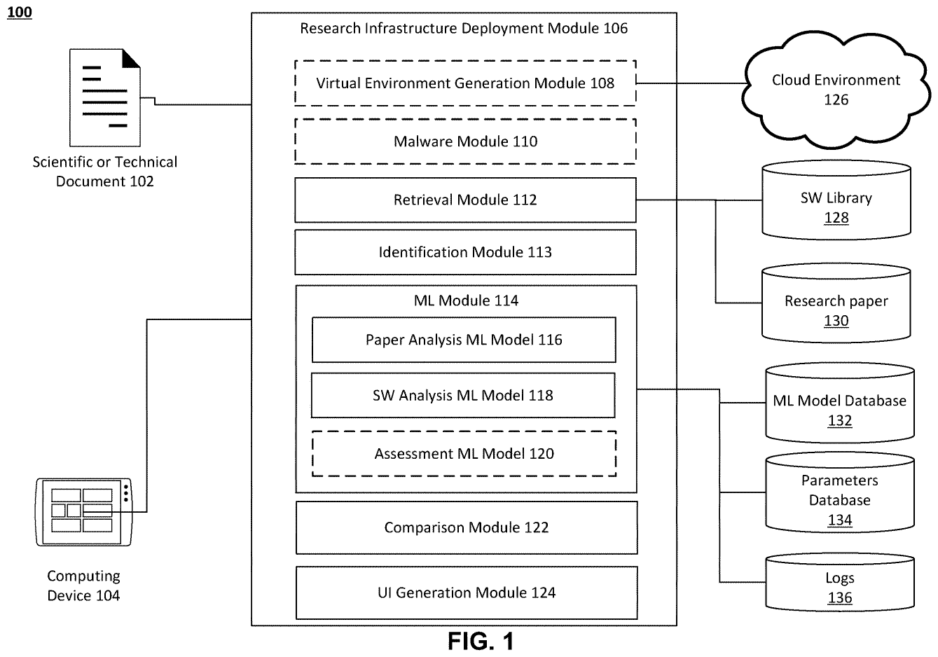

FIG. 1 is a block diagram illustrating a system 100 for analyzing scientific or technical documents and associated software code using machine learning according to aspects of the present disclosure. The system 100 may include a computing device 104, a scientific or technical document 102, and a research infrastructure deployment module 106, which may be a software installed on or accessed (e.g., via a virtual machine, container, web application) on the computing device 104. The computing device 104 allows for a user to control and configure the system 100 and view a UI. The computing device 104 may execute a plurality of modules in the research infrastructure deployment module 106 that together make up a retrieval, recognition, and analysis system. In some aspects, the research infrastructure deployment module 106 may correspond to the computing device 104 that is configured to execute a plurality of modules that together make up the research infrastructure deployment module 106.

Sharing software code in scientific or technical documents is a way to promote transparency, reproducibility, and collaboration, making it easier for the scientific community to validate, extend, or apply the research. It's particularly common in disciplines involving computational methods, data analysis, and software development. The research infrastructure deployment module 106 may be configured to build a suitable computational environment to run software code associated with a scientific or technical document 102 in order to validate the parameters, logic, methods, and/or results in the scientific or technical document 102.

In particular, the research infrastructure deployment module 106 may obtain at least one scientific or technical document 102 from a research paper database 130 for analysis and extracts parameters (e.g., dynamic parameters, Courant, Reynolds numbers) from the scientific or technical document, citations to the article, diagrams and links to a code repository. The research infrastructure deployment module 106 may then be configured to determine correspondence between parameters in the text of the article and parameters in the attached code for reconfiguration and analysis. The research infrastructure deployment module 106 may then use LLM to generate a script for creating a computation environment based on the combined requirements and context with suitable parameters of the instance. The research infrastructure deployment module 106 may then perform an assessment of whether the software code corresponds to the scientific or technical document and generates text explaining the results of the comparison using a text generation LLM.

The research infrastructure deployment module 106 may include an optional virtual environment generation module 108, an optional malware module 110, a retrieval module 112, an identification module 113, a machine learning module 114, a comparison module 122, and a user interface (UI) generation module 124. The research infrastructure deployment module may be connected to a cloud environment 126, a software library database 128, a research paper database 130, an ML model database 132, a parameters database 134, and/or a logs database 136. In some aspects, these databases may be hosted on the computing device 104 or a local machine. In some aspects, these databases may be hosted in a cloud environment 126. In some aspects, the research infrastructure deployment module 106 (specifically, the UI generation module 124) may generate a UI for display, which may be part of a client application associated with the research infrastructure deployment module 106. For example, the computing device 104 may be a device belonging to an end user such as a researcher or student.

The computing device 104 may execute a UI (not pictured) to obtain, from the user, a scientific or technical document 102 containing at least software code to run the methods, experiments, and/or tests explained in the article and corresponding parameters in the text of the article. For example, if the scientific or technical document corresponds to a chemistry article, the scientific or technical document may include code to execute computer simulations to validate the method or experiment in the chemistry article. For many users reading the article, they may not understand the software code in the article due to not being computer savvy or the code may be written in a different programing language.

Given the scientific or technical document 102 or a link to the scientific or technical document 102, the machine learning modules 114 from the research infrastructure deployment module 106 may generally perform a three-step process to: (1) understand, compare, and/or validate the results and/or code in the scientific or technical document 102 using trained machine learning models (e.g., neural networks, LLMs etc.), (2) understand the logic and parameters of the scientific or technical document 102 and code, and/or (3) generate text explaining the results of the logic and parameters using a text generation LLM.

In some aspects, the computing device 104 may execute an optional virtual environment generation module 108 configured to generate a suitable and secure computing environment configured to execute software code (e.g., C++, Python, MATLAB, etc.) attached to a scientific or technical document. In some aspects, the optional virtual environment generation module 108 may provide a cloud-based container to compare research articles to the code in the articles. In some examples, the optional virtual environment generation module 108 may provide a virtual machine, a container, a docket container, or a sandbox to compare research articles to the code in the articles.

Optionally, the computing device 104 may execute the optional malware module 110 configured to check the software code for malware and/or security vulnerabilities. Malware may be defined as code (whether it is part of a script or embedded in a software system) designed to cause damage, security breaches, or other threats to application security. In addition, based on a determination that the software code contains malware and/or security vulnerabilities, the optional malware module 110 may be configured to terminate execution of the software code to protect the system from the malware code. Malware code may cause major disruption to the computer and network since hackers can use the malware code to gain control of computers and passwords may be compromised.

In some aspects, the computing device 104 may execute a retrieval module 112 configured to retrieve a scientific or technical document and a software code associated with the scientific or technical document. In some aspects, the retrieval module 112 may access the software library database 128 and/or the research paper database 130. In some aspects, the retrieval module 112 may obtain a description of the subject matter, logic, algorithms, and/or parameters from external sources. In some aspects, the retrieval module 112 may access the scientific or technical documents and the associated software code from the internet or any other suitable sources.

In some aspects, the computing device 104 may execute an identification module 113 configured to identify subject matter, logic, algorithms, and/or parameters from the scientific or technical document 102. In some aspects, the computing device 104 may execute the identification module 113 configured to identify subject matter, logic, algorithms, and/or parameters represented in portions of the software code based on the obtained description of the subject matter, logic, algorithms, and/or parameters from external sources.

The computing device 104 may execute a machine learning module 114 including a paper analysis ML model 116, a software analysis ML model 118, and an assessment ML model 120. First, a trained paper analysis ML model 116 is configured to identify subject matter, algorithms, parameters, and/or logic of the scientific or technical document 102 using a text interpretation LLM. Second, a trained SW analysis ML model 118 is configured to analyze software code associated with the scientific or technical document 102 to also identify subject matter, algorithms, parameters, and/or logic of the software code using software code from a software library database 128. Third, an optional trained assessment ML model 120 may be configured to perform the assessment of whether the software code corresponds to the scientific or technical document 102 and generates text explaining the results of the comparison using a text generation LLM.

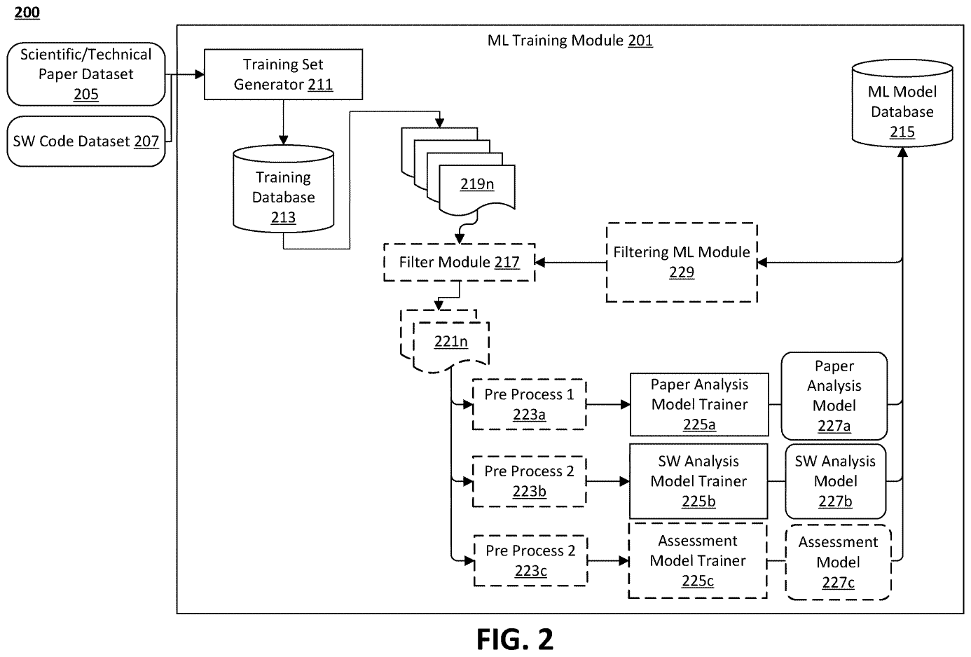

In some aspects, the paper analysis ML model 116, the software analysis ML model 118, and the optional assessment ML model 120 may contain specifically trained LLMs. An LLM is a type of AI designed to understand and generate human language. LLMs are trained on vast amounts of text data, enabling them to perform a wide range of language-related tasks such as answering questions, summarizing text, translating languages, or generating content. LLMs, such as GPT (generative pretrained transformer), use deep learning techniques to recognize patterns, learn context, and predict word sequences making them highly versatile in natural language processing applications. Accordingly, the LLMs in the paper analysis ML model 116, the software analysis ML model 118, and the optional assessment ML model 120 must first go through training to teach the LLMs to perform their respective specific tasks. Further details about the training of each respective ML model will be described in FIG. 2.

A transformer is a deep learning architecture used in LLMs. The transformer has an encoder/decoder structure with numerous stacked multi-head attention layers and feed forward network layers. This architecture allows the model to process and generate text effectively, capturing long-range dependencies and contextual information. Transformers are well-suited for tasks like natural language processing, and image classification and generation. Common examples of transformer models are generative pre-trained transformer (GPT) and Bidirectional Encoder Representations from Transformers (BERT).

For LLM tasks such as text summarization, code explanation, code writing, and informational retrieval, an untrained LLM in the paper analysis ML model 116 will first analyze the text from the scientific or technical documents to identify a subject matter, logic, algorithms, and/or parameters by learning and categorizing distinct characteristics that define subject matter, logic, algorithms, and/or parameters. As an example, the training dataset may include labeled training data consisting of scientific or technical documents and their corresponding ground truth labels (e.g., topic, parameters, or logic). Accordingly, since the paper analysis ML model 116 is designed to identify and classify objects from different classes (e.g., each individual topic, parameter, or logic), then the training data will need samples from each topic, parameter, or logic that is to be identified. Typically, thousands of samples from each class may be required. During training of the LLM, the training dataset comprises data from scientific or technical documents that are input through an untrained LLM model in the paper analysis ML model 116. The results from the untrained LLM are then compared with known data set results using the corresponding topic, parameter, and logic labels identifying each subject matter, logic, algorithms, and/or parameters in the training data. It should be noted that the input to the paper analysis ML model 116 will only be the scientific or technical documents from the training dataset.

For every input training sample from the training dataset, the LLM from the paper analysis ML model 116 will produce a prediction consisting of values representing the probability that the input document corresponds to a given class (e.g., a given subject matter, logic, algorithms, and/or parameter). The output with the highest probability determines the predicted label. A class label for each input document is used to compute a loss (e.g., loss function).

The paper analysis ML model 116 then uses a loss function that quantifies the error between the predicted output and the ground truth (e.g., subject matter label, logic label, algorithm label, and/or parameter label) for a given training sample. In other words, the loss function can be used to guide the learning process by updating the network weights in a way that improves the accuracy of future predictions. This process may continue until the difference between the prediction and the correct targets is minimal.

Once the LLM is trained, during inference, the paper analysis ML model 116 may identify characteristics of subject matter, logic, algorithms, and/or parameters within the text of the scientific or technical documents to identify the topic, parameters, and logic within the text. Specifically, the paper analysis ML model 116 contains a trained LLM configured to perform text classification tasks by leveraging an underlying architecture, typically built on transformer-based models. For example, the LLMS perform text classification by understanding the input context using self-attention mechanisms, extracting semantic meaning, and mapping that to a classification label through a final softmax layer. In addition, fine-tuning is key to making the LLMS effective for specific classification tasks.

During inference, the trained LLM from the paper analysis ML model 116 does not re-evaluate or adjust the layers of the LLM based on the results. Instead, the inference applies knowledge from the trained LLM and uses it to infer a result (e.g., what subject matter the scientific or technical document pertains to, the parameters in the scientific or technical document, the algorithms in the scientific or technical document, or the logic in the scientific or technical document). Accordingly, when a new unknown dataset (e.g., scientific or technical document 102) is input through the trained LLM in the paper analysis ML model 116, the trained LLM outputs a prediction of what subject matter, logic, algorithms, and/or parameters are present in the text of the scientific or technical document 102 based on predictive accuracy of the LLM.

Similar to the paper analysis ML model 116, the trained software analysis ML model 118 is configured to identify characteristics of subject matter, logic, algorithms, and/or parameters within the text of software code associated with the scientific or technical document 102. Accordingly, the explanation of the setup, training, and inference of the trained paper analysis ML model 116 applies to the software analysis ML model 118 in the context of software code rather than scientific or technical documents.

The optional assessment ML model 120 is configured to perform an assessment of whether the software code corresponds to the scientific or technical document 102 and to generate text explaining the results of the comparing using a text generation LLM. For the assessment of whether the software code corresponds to the scientific or technical document, the assessment ML model 120 may use machine learning to compare the software code and the scientific or technical document 102 to determine their similarity, rank, or relationship. As a non-limiting example, the assessment ML model 120 may use a Siamese network to compare the software code and scientific or technical document 102 to compute similarity. The Siamese network may consist of two identical neural networks (with shared weights) that take two inputs and generate embeddings for both. The embeddings are then compared using a similarity metric like cosine similarity or Euclidean distance. As another example, the assessment ML model 120 may use a BERT-based model (transformer model) to compare text by encoding sentences into embeddings and then comparing those embeddings. For this type of assessment, BERT can be fine-tuned on specific tasks like semantic similarity or ranking. As yet another example, the assessment ML model 120 may use a support vector machine (SVM) with kernels to learn a decision boundary (hyperplane) that separates two classes by maximizing the margin between them. It should be noted that the machine learning models listed above are for illustrative purposes only, and any suitable machine learning model for comparison may be used in the assessment ML model 120.

For generating text explaining the results of the comparing using a text generation LLM, the assessment ML model 120 works by predicting and generating coherent sequences of text based on the input it receives. The core mechanism behind text generation in LLMs also relies on the transformer architecture, which allows the model to generate contextually relevant text by understanding patterns, meanings, and structures within the input data.

Text generating models are typically pre-trained on massive datasets, such as books, articles, websites, and other text sources. During training, the model learns the statistical relationships between words, phrases, sentences, and broader structures like paragraphs. The goal of the training phase is to learn to predict the next word in a sequence given the previous words. LLMs like GPT are trained using unsupervised learning with a language modeling objective. Specifically, they are trained to minimize the difference between the predicted next word and the actual next word in a sequence of text. The model sees massive amounts of text data, capturing patterns of grammar, facts, knowledge, and even some logical reasoning. During training, the model learns relationships between words, like which words often follow others, how grammar works, and how various linguistic features (e.g., tense, tone, formality) play out in context.

Before any text is processed, it needs to be tokenized. Tokenization breaks the input text into smaller units, usually sub-word tokens. Each token is then converted into a numerical vector (embedding) that represents its meaning. These embeddings are used as inputs to the transformer model. The transformer architecture, which powers text generation LLMs, uses a mechanism called self-attention to understand the context of the input text. Self-attention allows the model to consider the relationship between every word in the input sequence and all other words, regardless of their distance in the text. This helps the model generate contextually relevant text.

LLMs consist of multiple layers of transformer blocks, each containing self-attention and feedforward neural networks. As the input text passes through these layers, the model refines its understanding of the context at increasingly abstract levels. Early layers learn basic relationships, such as grammar and word meanings, while deeper layers learn more complex patterns, such as sentence structure, logical relationships, and nuanced meanings. To prevent information loss across layers, residual connections are used to pass information from earlier layers directly to later layers.

When generating text, LLMs work in an auto-regressive fashion, meaning they generate one token at a time, using the previously generated tokens as context for predicting the next token. Once the model has generated all the tokens, the output is decoded back into human-readable text. The final result is a sequence of words, sentences, or even paragraphs that form a coherent response to the input prompt. While LLMs are pre-trained on large amounts of general data, they can be fine-tuned on specific datasets to improve performance for specific tasks like text generation, summarization, or dialogue. Fine-tuning adjusts the model's parameters to better align with a specific task's goals.

The computing device 104 may execute a comparison module 122 configured to identify corresponding algorithms and parameters in the scientific or technical document 102 and the software code. Specifically, the comparison module 122 may compare subject matter, logic, algorithms, and/or parameters of the scientific or technical document 102 with the subject matter, logic, algorithms, and/or parameters of the associated software code in order to identify corresponding subject matter, logic, algorithms, and/or parameters between the scientific or technical document 102 and the software code.

The computing device 104 may execute a configuration module (not pictured) configured to adjust parameters or values of the parameters in the software code. Specifically, the configuration module may generate prompts based on the parameters of the code and create a script for changing parameters in terms of the software code. After the parameters or values of the parameters are adjusted, the code may be re-executed with the updated parameters and the results are re-analyzed.

The computing device 104 may execute a UI generation module 124 configured to receive inputs from a user and display, in a UI, corresponding algorithms and parameters in the scientific or technical document 102 and the software code. In some aspects, the UI may also display computer-generated text explaining the results of the comparison.

It should be noted that the identification of subject matter, parameters, and/or logic of the scientific or technical document 102 and corresponding software code is heavily simplified. One of those skilled in the art will appreciate that the machine learning models utilized may have significantly large datasets with highly specific details. For example, there may be hundreds of parameters in each scientific or technical document. The analysis may be beyond the capabilities of the human mind because the amount of data to be identified and analyzed in each scientific or technical document is unfathomable.

FIG. 2 is a block diagram illustrating a system for training machine learning models to identifying logic, algorithms, and/or parameters of scientific or technical documents and associated software code.

As shown in example 200, a machine learning training module 201 is configured to build and train specialized machine learning models with inference to perform particular tasks. In this way, the specialized machine learning models may develop an ability to perform particular objectives within new data that is not part of a training dataset. By subjecting the specialized machine learning models to large amounts of unlabeled and/or labeled trained data sets, the specialized machine learning models may perform particular tasks such as identifying subject matter, parameters, algorithms and/or logic in the scientific or technical document and corresponding software code, perform an assessment of whether the software code corresponds to the scientific or technical document, and/or generate text explaining the results of the comparison using a text generation LLM.

Supervised learning is effective for tasks such as classification (assigning inputs to predefined categories) and regression (predicting continuous values) since it relies on the availability of labeled data for both training and evaluation phases. In supervised learning, the machine learning training module 201 trains the algorithm on a labeled dataset, where each input has a corresponding output. The goal is to learn a mapping function from inputs to outputs, allowing the algorithm to make predictions or classifications on new, unseen data. The process typically involves the following steps: training, model building, prediction, feedback, and adjustment.

In the training phase, the machine learning training module 201 provides the algorithm with a training dataset including input-output pairs. The algorithm learns the mapping function that relates inputs to outputs through an iterative process, adjusting its internal parameters based on the provided examples. During model building, the algorithm creates a model that can generalize from the training data to make predictions on new, unseen data. The model's complexity varies based on the algorithm used. For example, the model may be a simple linear regression model or a complex neural network. During the prediction phase, the machine learning training module 201 inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, machine refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem.

In some aspects, the machine learning training module 201 contains at least a training database 213 configured to store the raw training data 219n and corresponding labels, a machine learning model database 215 to store the trained models (e.g., paper analysis model 227a, software analysis model 227b, and/or assessment model 227b). In some aspects, the machine learning training module 201 may contain an optional filtering machine learning model 229 and an optional filter module 217 configured to filter data from the training database 213 for training by removing bad training data.

Training data from the research paper dataset 205 and software code dataset 207 is received into the machine learning training module 201 via the training set generator 211. In some aspects, a research paper dataset 205 may include scientific or technical documents with logic, algorithms, and/or parameters and corresponding software code. In some aspects, the software code dataset 207 may include software code and corresponding logic, algorithms, and/or parameters.

An optional filter module 217 is configured to filter out bad training data in order to claim up the training data in the training dataset 219n. In some examples, the optional filter module 217 may be a neural network. In some examples, the optional filter module 217 is a simple mathematical model. In some examples, the cleaned training dataset 221n then undergoes optional preprocessing steps depending on which neural network or model is being trained.

The optional preprocess 1 424a, preprocess 2 424b, and preprocess 3 424c are automated processes that modify the raw data received from 219n (or cleaned training dataset 221n) and prepare the raw data as input to the respective model trainers (e.g., a paper analysis model trainer 225a, a software analysis model trainer 225b, and an assessment model trainer 225b). These may be described in the machine learning training module 201 as snippets of code that prepares the datasets. In some examples, the preprocessing module (e.g., preprocess 1 223a, preprocess 2 223b, and preprocess 3 223c) for a particular trainer may be an automated script or code that will be set up the first time any model is trained.

The paper analysis model trainer 225a, the software analysis model trainer 225b, and the optional assessment model trainer 225c are the scripts or code that train the model. The paper analysis model trainer 225a, the software analysis model trainer 225b, and the optional assessment model trainer 225c may be a script or code that holds the instructions on how a model should be trained (e.g., optimization method, model architecture, dataset division, etc.) and also runs the training. The paper analysis model trainer 225a, the SW analysis model trainer 225b, and the optional assessment model trainer 225c each take as input the raw or filtered processed training data and train the paper analysis model 227a, the software analysis model 227b, and the optional assessment model 227c to achieve their specific objectives, respectively.

In summary, the raw dataset 219n or cleaned dataset 221n may optionally go through different preprocessing steps 223a, 223b, and 223c and then a corresponding paper analysis model trainer 225a, a software analysis model trainer 225b, and an assessment model trainer 225c to generate a trained paper analysis model 227a, a software analysis model 227b, and an assessment model 227c. In some examples, each of these models may be an LLM.

The LLMs are trained through a multi-step process involving vast amounts of text data and sophisticated machine learning techniques. The training generally occurs in three stages: pre-training, fine-tuning, and scaling. The first step generally includes data collection since LLMs require massive amounts of text data to learn the patterns, structures, and relationships in language. The goal is to expose the model to a wide variety of text forms, genres, and topics to help it generalize well to different contexts. In the pre-training phase, the model is then trained on a large corpus of text in an unsupervised manner, typically using self-supervised learning techniques. The most common training objective is language modeling. The training may be done using a neural network architecture called the transformer, which excels at capturing long-range dependencies in text. Pre-training allows the model to learn grammar, facts about the world, and how language is structured.

Key components during the pre-training phase include: a transformer architecture, an attention mechanism, and tokenization. A transformer architecture may be composed of layers of self-attention mechanisms and feed-forward networks, which enable the model to focus on different parts of the input. Next, attention mechanism allows the model to weigh the importance of different words in the context of others, helping it understand relationships in text better than traditional models. Text is then broken into smaller units (e.g., tokens), like words or sub-words, to make it easier for the model to process.

After pre-training, the model undergoes fine-tuning to adapt it to more specific tasks, such as question answering, summarization, or chatbot interaction. Fine-tuning uses smaller, task-specific datasets and often involves supervised learning. The model may be exposed to labeled data where inputs (e.g., questions) are paired with expected outputs (e.g., answers) so it can adjust its internal parameters to better perform on that specific task. During training, the model's predictions are compared to the correct answers, and the differences (errors) are minimized using a loss function like cross-entropy loss. The model's parameters are updated via optimization algorithms like stochastic gradient descent (SGD) or its variants (e.g., Adam optimizer) to reduce the loss and improve performance.

Once the LLMs are set up, LLMs may be scaled by using more data such as pre-training on larger datasets to improve generalization. LLMs also use hundreds of billions of parameters, increasing their capacity to capture complex language relationships. Models may also be trained for millions of iterations on powerful distributed hardware (e.g., GPUs, TPUs) to refine their internal representations.

The raw training dataset 219n used for training may contain noise and bad training images from the training database 213. Accordingly, to create a clean and filtered training dataset, the optional filter module 217 is configured to filter out unwanted data points from the raw training dataset 219n by developing smaller, less accurate systems based on patterns and metadata information. For example, an automated system may be created to identify different subjects, parameters, algorithms, and/or logic using a trained paper analysis model 227a to analyze different scientific or technical documents. The resulting training dataset 221n may consist of scientific or technical documents and labels, where each scientific or technical document contains labeled subjects, parameters and/or logic.

When a new model (e.g., a trained paper analysis model 227a, a software analysis model 227b, and an optional assessment model 227c) is created, and a new process for filtering and automated labeling is established, it is added to the machine learning model database 215 in the machine learning training module 201. This enables the new model to be part of the closed-loop model update process. Optionally, at regular intervals, data which is continuously collected can be filtered, labeled, and used to update old models by an optional filtering machine learning module 229. In some examples, the optional filtering machine learning module 229 is a neural network. In some examples, the optional filtering machine learning module 229 is a simple mathematical model.

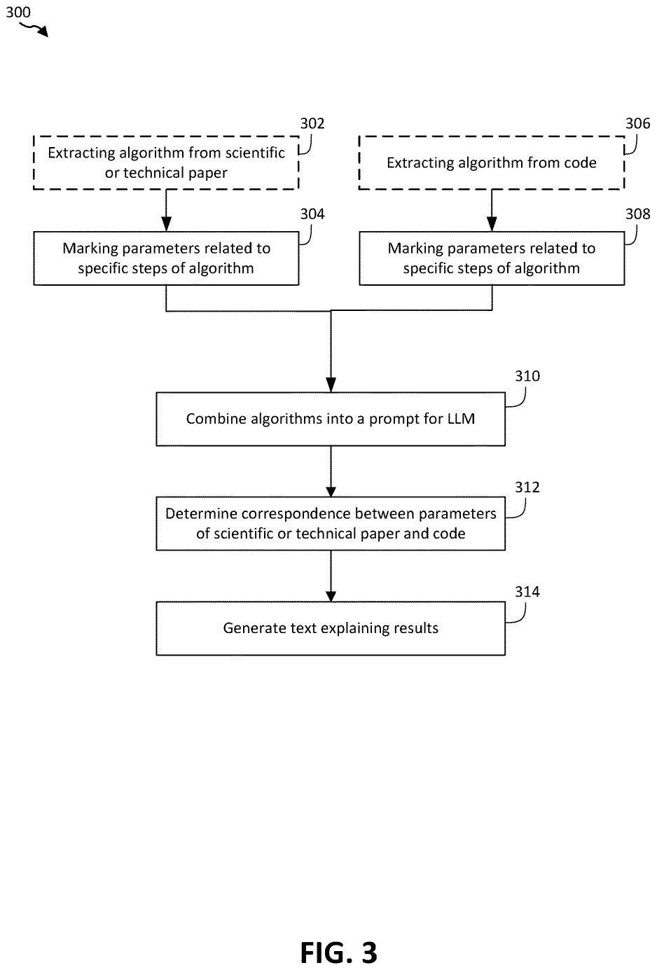

FIG. 3 is a flow diagram of a method for finding correspondence between parameters according to aspects of the present disclosure. In various implementations, the method 300 is performed by a device with one or more processors and non-transitory memory that performs intent prediction. In some implementations, the method 300 is performed by processing logic, including hardware, firmware, software, or a combination thereof. In some implementations, the method 300 is performed by a processor executing code stored in a non-transitory storage computer-readable medium (e.g., a memory).

Optionally, at 302, the method 300 includes extracting an algorithm (or logic) from a scientific or technical document. Optionally, at 304, the method 300 includes marking parameters related to specific steps of the algorithm. In some aspects, the method 300 includes identifying scientific features such as names of algorithms and parameters from the scientific or technical document and obtaining descriptions of the algorithms and parameters from external sources. In some aspects, the method 300 may include marking parameters from the scientific or technical document, citations in the scientific or technical document, and diagrams in the scientific or technical document.

At 306, the method 300 includes extracting an algorithm from software code associated with the scientific or technical document. At 308, the method 300 includes marking parameters related to specific steps of the algorithm.

At 310, the method 300 includes combining the algorithms into a prompt for an LLM. In some aspects, this step may include using the LLM to find correspondence between parameters in the scientific or technical document and in the corresponding software code.

At 312, the method 300 includes determining a correspondence between parameters of the scientific or technical document and the software code. This step is necessary because the scientific or technical document may use one set of parameters and values and the software code may use a different set of parameters and values. In this way, the logic of the code may be understood such that each parameter in the scientific or technical document has a mapping to a parameter in the software code.

In some aspects, context may be uploaded for finding correspondence between parameters by a human or via an LLM.

At 314, the method 300 includes generating text explaining results of the correspondence. In this way, a user may understand the logic of the article and code and understand what each parameter means.

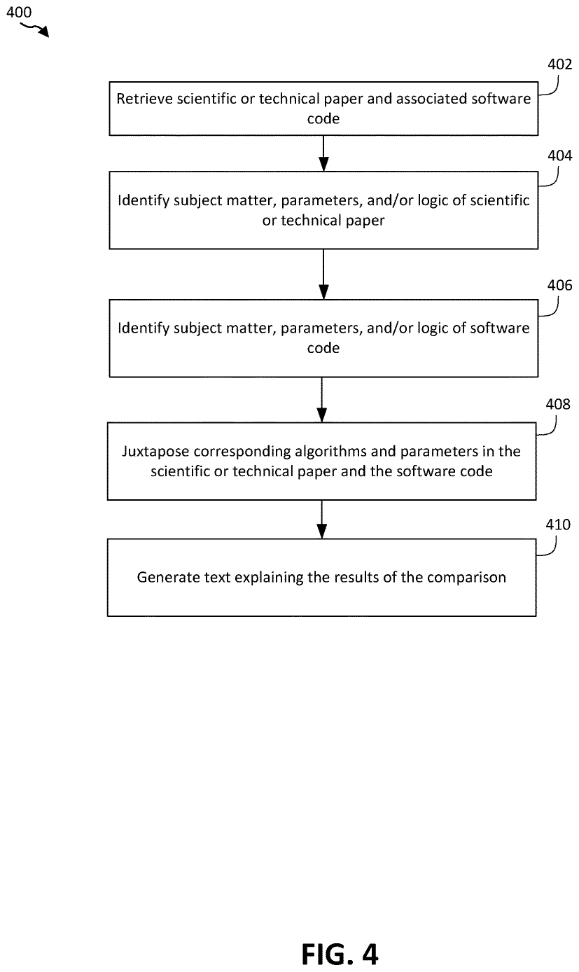

FIG. 4 is a flow diagram of a method for machine learning (ML)-assisted analysis of scientific or technical documents and associated software code according to aspects of the present disclosure. In various implementations, the method 400 is performed by a device with one or more processors and non-transitory memory that performs intent prediction. In some implementations, the method 400 is performed by processing logic, including hardware, firmware, software, or a combination thereof. In some implementations, the method 400 is performed by a processor executing code stored in a non-transitory computer-readable storage medium (e.g., a memory). The method 400 includes at least analyzing a scientific or technical document and software code associated with the scientific or technical document to create a correspondence between subject matter, logic, algorithms, and/or parameters in the text of the scientific or technical document and parameters in the software code for analysis and/or reconfiguration.

One of the key principles of scientific research is verification and reproducibility, meaning that other researchers should be able to replicate the results described in the scientific or technical document. By providing an accompanying computer code, researchers provide transparency and enable others to verify their findings or build on their work. This is especially important in fields like computational sciences, machine learning, and bioinformatics.

At 402, the method 400 may include retrieving a scientific or technical document and a software code associated with the scientific or technical document. The software code may include executable code and/or source code. In some aspects, the method 400 may include retrieving a link to the software code and running the software code in a dedicated, secure computing environment for analyzing logic and/or parameters of the software code. As an example, referring back to FIG. 1, a retrieval module 112 may be configured to retrieve a scientific or technical document and a software code associated with the scientific or technical document.

In some aspects, the method 400 may include extracting parameters (e.g., dynamic parameters, Courant, Reynolds numbers, etc.) from the scientific or technical document, citations in the scientific or technical document, diagrams in the scientific or technical document, and links to the code repository.

At 404, the method 400 may include identifying scientific features including at least one of subject matter, logic, algorithms, and/or parameters represented in the scientific or technical document by analyzing the scientific or technical document by analyzing the scientific or technical document for the scientific features. In some aspects, the scientific features include at least data structures, functions, and variables of the functions.

Optionally, method 400 may include analyzing the scientific or technical document using a trained paper analysis ML model configured to identify the scientific features represented in the scientific or technical document. In some aspects, the scientific features may include logic, algorithms, and/or parameters of the scientific or technical document that include at least data sets, equations and parameters of the equations. As an example, referring back to FIG. 1, a trained paper analysis ML model may be configured to identify scientific features including at least one of subject matter, algorithms, parameters, and/or logic of the scientific or technical document 102 using a text interpretation LLM.

In some aspects, the method 400 may include preparing the paper analysis ML model based on a text interpretation LLM to identify different subject matters, logic, algorithms, and/or parameters using one or more other scientific or technical documents from a research paper database. This may involve leveraging techniques from natural language processing (NLP), program analysis, and machine learning. Once the paper analysis ML model is sufficiently trained and validated, the paper analysis ML model may be deployed as a service (e.g., API) or integrated into a larger code analysis tool or development environment.

In some aspects, the method 400 may include preparing the software analysis ML model to identify different subjects, parameters, and/or logic using one or more software code from a code database.

In some aspects, identifying the corresponding scientific features represented in the analyzed software code is based at least in part on searching for scientific features in the software code using the trained software analysis ML model.

In some aspects, searching for the scientific features in the software code further comprises: obtaining partial algorithms in the scientific or technical document and the software code; identifying scientific features in the partial algorithms in the software code that are similar to the identified scientific features of the partial algorithms in the scientific or technical document; juxtaposing the scientific features found in the partial algorithms in the scientific or technical document and in the partial algorithms in the software code; and determining similarities between the scientific features found in the partial algorithms in the scientific or technical document and partial algorithms in the software code.

In some aspects, searching for scientific features in the software code further includes: benchmarking the results of the search and displaying a level of confidence corresponding to a similarity of each identified methodology feature represented in the software code with the identified methodology feature represented in the scientific or technical document.

Optionally, in some aspects, the method 400 may include identifying corresponding parameters in the scientific or technical document and the software code by juxtaposing the scientific features of the scientific or technical document with the features of algorithms and parameters of the associated software code; and displaying, in the user interface, at least the identified corresponding parameters in the scientific or technical document and the software code.

At 406, the method 400 may include obtaining a description of the identified scientific features from external sources. In some aspects, the method 400 may include displaying the description of the scientific features to the user for confirmation.

Optionally, the method 400 may include analyzing portions of the software code using a trained software analysis ML model configured to identify scientific features from the scientific or technical document in the software code using a trained software analysis ML model configured to identify the corresponding scientific features represented in the analyzed software code based on the obtained description of the identified scientific features represented in the scientific or technical document. The portions of the software code being identified based on external sources. As an example, referring back to FIG. 1, a trained software analysis ML model 118 may be configured to analyze software code associated with the scientific or technical document to also identify subject matter, algorithms, parameters, and/or logic of the software code using software code from a software library database 128.

As an example, if a methodology feature such as Reynolds number is identified in the article and then a comment in the corresponding software code indicating a “Reynolds number” alongside a variable named “RNDN”, then the software analysis ML model 118 can infer that the RNDN variable pertains to the Reynolds number. Alternatively, if a variable itself is named “ReynoldN”, then the software analysis ML model 118 may correctly predict that the variable “ReynoldN” relates to the Reynolds number.

In some aspects, the method 400 may include training the software analysis ML model to identify different subject matter, logic, algorithms, and/or parameters using one or more software code from a code database. To analyze software code using the trained software analysis ML model, the software code may be preprocessed, run inference with the trained software analysis ML model, and interpret the output including at least identification of subject matter, logic patterns, specific algorithms and/or parameters used in the software code. By interpreting and visualizing the trained software analysis ML model's output, the method 400 may generate detailed insights into the code structure and functionality.

In some aspects, analyzing the software code may include: generating a secure virtual environment configured to execute software code; and executing the software code in the secure virtual environment. In some aspects, the security virtual environment may include one of a virtual machine, a container, or a sandbox. As an example, referring to FIG. 1, an optional virtual environment generation module 108 may be configured to generate a suitable and secure computing environment configured to execute software code (e.g., C++, Python, MATLAB, etc.) attached to a scientific or technical document.

Generating and executing software code in a secure virtual environment offers a wide range of benefits, including improved security, isolation, and reproducibility, as well as efficient resource management. These environments help protect the host system from potential risks, streamline dependency management, facilitate testing and debugging, and enhance portability across platforms. For developers, testers, and system administrators, virtual environments provide a safe and consistent way to execute code, ensuring that software runs reliably in various configurations while minimizing risk to the host system.

In some aspects, executing the software code may include: retrieving and utilizing one or more software libraries for the execution of the software code. The software libraries help execute, manage, and even secure code, offering environments for testing, development, deployment, or scripting. These software libraries and frameworks provide various methods for executing code across multiple domains, whether for testing, development, high-performance computing, or large-scale data processing. The appropriate tool may be selected depending on requirements (e.g., secure execution, distributed processing, or containerized environments) to ensure efficient and secure code execution.

In some aspects, executing the software code may include: checking the software code for malware and/or security vulnerabilities; and based on a determination that the software code contains malware and/or serious security vulnerabilities, terminating execution of the software code. As an example, referring back to FIG. 1, an optional malware module 110 may be configured to check the software code for malware and/or security vulnerabilities, and, based on a determination that the software code contains malware and/or security vulnerabilities, the optional malware module 110 may be configured to terminate execution of the software code to protect the system from the malware code.

In some aspects, the method 400 may further include uploading context for configuring the secure virtual environment and/or finding correspondence between parameters by an agent (e.g., human or LLM). This may include at least: finding the project on a code repository (e.g., GitHub), recognizing the programming language of the project, defining parameters for the code, environment, and requirements, recognizing the programming language of the project, searching for descriptions of libraries, gathering additional information from similar projects, handling voice input to check the sufficiency of requirements and parameters; and using the LLM to ask users additional questions about other requirements and parameters.

In some aspects, an LLM may be used to generate a script for creating a computational/virtual environment (VM) based on the combined requirements and context with suitable parameters of the instance (e.g., GPU, CPU, ARM, memory, disk, versions, or other requirements). The computational/VM is a software environment that allows users to run and test code or simulations in an isolated, controlled space, separate from the main system environment. This isolation helps in managing dependencies, libraries, and settings specific to a project or task without affecting or conflicting with other environments on the system. Next, an instance (e.g., container) may be generated for processing the code based on the parameters. Containers are lightweight environments that package code, libraries, and dependencies together.

At 408, the method 400 may include juxtaposing subject matter, logic, algorithms, and/or parameters of the scientific or technical document with the subject matter, logic, algorithms, and/or parameters of the associated software code to identify corresponding subject matter, logic, algorithms, and/or parameters in the scientific or technical document and the software code. As an example, referring back to FIG. 1, a comparison module 122 may be configured to identify corresponding algorithms and parameters in the scientific or technical document and the software code by comparing subject matter, logic, algorithms, and/or parameters of the scientific or technical document with the subject matter, logic, algorithms, and/or parameters of the associated software code in order to identify corresponding subject matter, logic, algorithms, and/or parameters between the scientific or technical document and the software code.

In some aspects, identifying the correspondence between the software code and the scientific or technical document further comprising: preparing and executing an assessment ML model to perform the assessment of whether the software code corresponds to the scientific or technical document, based on a training dataset comprising scientific or technical documents and corresponding software code, and to generate text explaining the results of the comparison using a text generation LLM. As an example, referring back to FIG. 1, an optional trained assessment ML model 120 may be configured to perform the assessment of whether the software code corresponds to the scientific or technical document 102 and generates text explaining the results of the comparison using a text generation LLM.

In some aspects, assessing whether the software code corresponds to the scientific or technical document further comprises: extracting scientific features from the scientific or technical documents and corresponding software code; marking parameters from the scientific or technical documents related to specific steps of the extracted features; combining the algorithms from the scientific or technical documents and the algorithms from the corresponding software code into prompts for the trained assessment ML model; and determining correspondences between the extracted parameters and corresponding values from text of the scientific or technical documents and parameters and corresponding values from the corresponding software code using the trained assessment ML model.

At 410, the method 400 may include displaying, in a user interface, at least the corresponding scientific features from the scientific or technical document and the software code. In this way, a user may confirm or correct the identified parameters between the scientific or technical document and the software code. As an example, referring back to FIG. 1, UI generation module 124 configured to receive inputs from a user and display, in a UI, corresponding algorithms and parameters in the scientific or technical document and the software code.

In some aspects, the method 400 may include displaying, in the user interface, parameters in the software code using a visual indicator configured to accept, deny, or edit correspondence. This allows a user to easily view and find where particular parameters are presented in the software code.

In some aspects, the method 400 may further include: obtaining a modification of at least one parameter in the software code; and executing the software code with the modified at least one parameter. In this way, a user may find and correct an incorrect parameter in the software code and re-execute the computer code with the modified parameter. A user may modify a parameter by using language commands, configuration files, or any suitable means.

In some aspects, the method 400 may include allowing a user to change parameters in the software code. As an example, the user may modify the variables and observe the impact on the calculation results. As another example, a Reynolds number may be found in the software code and the user can change the value of the Reynolds number within the UI to re-execute the code with a different parameter. A user may want to change the Reynolds number in the software code and re-execute the code for a variety of reasons, particularly related to exploring fluid dynamics, validating results, or studying new scenarios. As an example, the user may want to explore fluid behavior at different flow regimes and since the Reynolds number is a critical parameter in determining whether the flow is laminar, turbulent, or in transition-changing it allows the user to study how fluid behavior evolves across these regimes. Users might want to investigate Reynolds numbers beyond those analyzed in the paper to explore new flow conditions or phenomena. As another example, the user may want to determine the impact of the Reynolds number such that by changing the Reynolds number, the user can study how sensitive a system's behavior (e.g., drag, heat transfer, or mixing) is to changes in flow characteristics. As yet another example, a user may want to validate computational or theorical results against experimental data that involves different Reynolds numbers. Users may also need to reproduce the findings of a scientific paper by running simulations at the same or similar Reynolds numbers used in the study.

The above descriptions provide various embodiments of automatically setting up computing environments and mapping parameters between a scientific or technical document to associated software code. However, significant challenges remain when the software code or the computing environment fails during execution. Automated setup tools can reduce the initial burden of environment configuration, but they generally do not address what happens when the software code still does not run correctly. Failures may arise from incompatible dependency versions, missing preprocessing steps, broken file paths, or subtle mismatches between the software code and the conditions described in the scientific or technical document. Diagnosing and resolving these failures still falls on the researcher, who must manually inspect error messages, search for fixes, and re-run the software code through repeated trial and error.

Moreover, related approaches treat each research project's failures independently, even though research projects in the same scientific domain or using similar algorithms tend to encounter the same kinds of problems. The knowledge gained from fixing one research project is not captured or reused to help fix the next. Therebefore, there is a need for a system that can systematically learn from prior execution failures and their resolutions, organize that knowledge into a structured and reusable taxonomy, and automatically apply it to diagnose and repair both environment-level and code-level problems in new projects. Such a system can further reduce the manual effort required to reproduce executable software code and continuously improve its effectiveness as it encounters and resolves new types of failures.

The disclosure provides systems and methods for generating a code-failure taxonomy for remediating failures in executing software code.

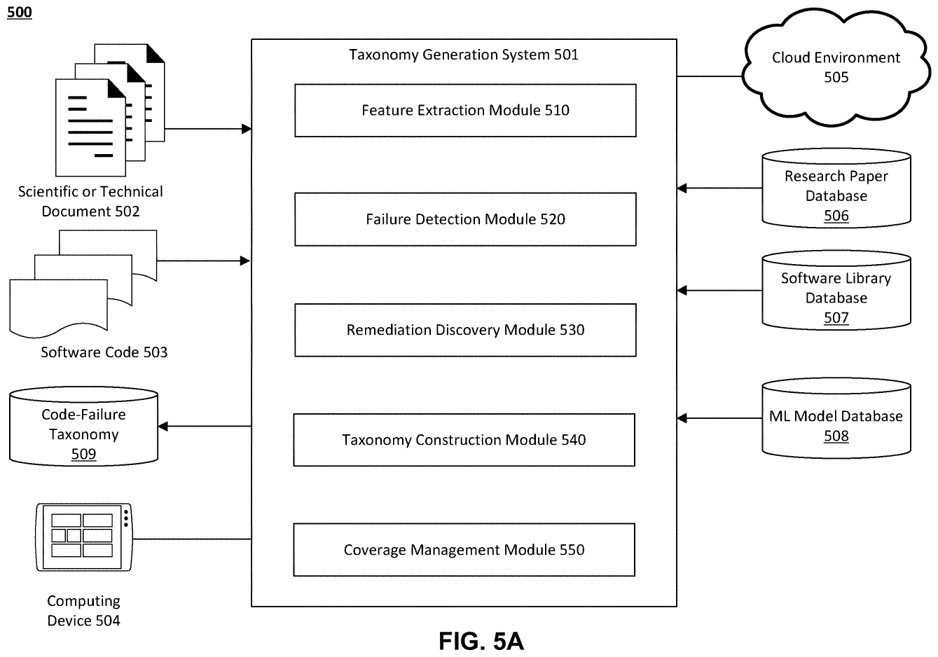

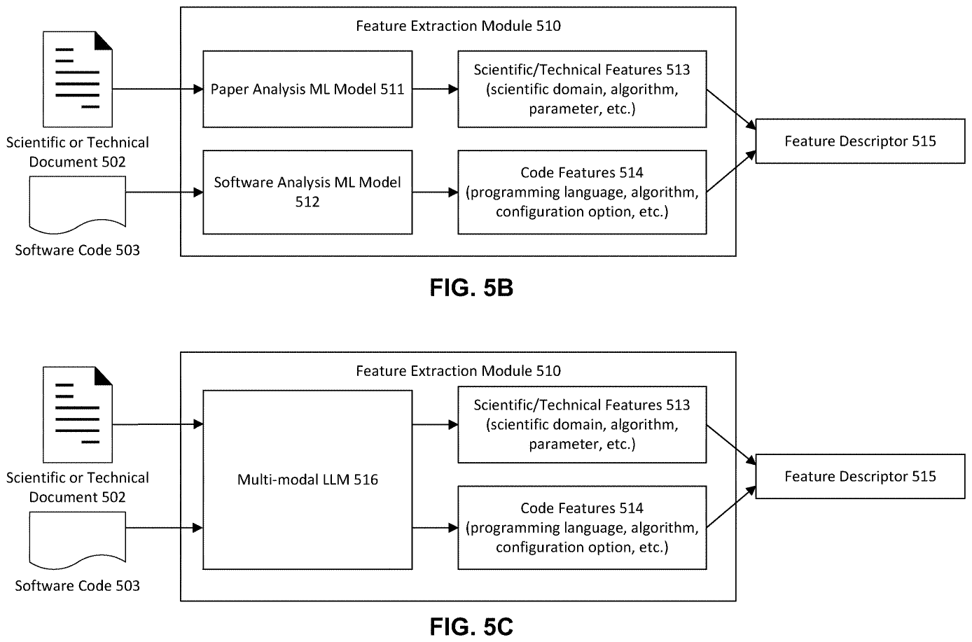

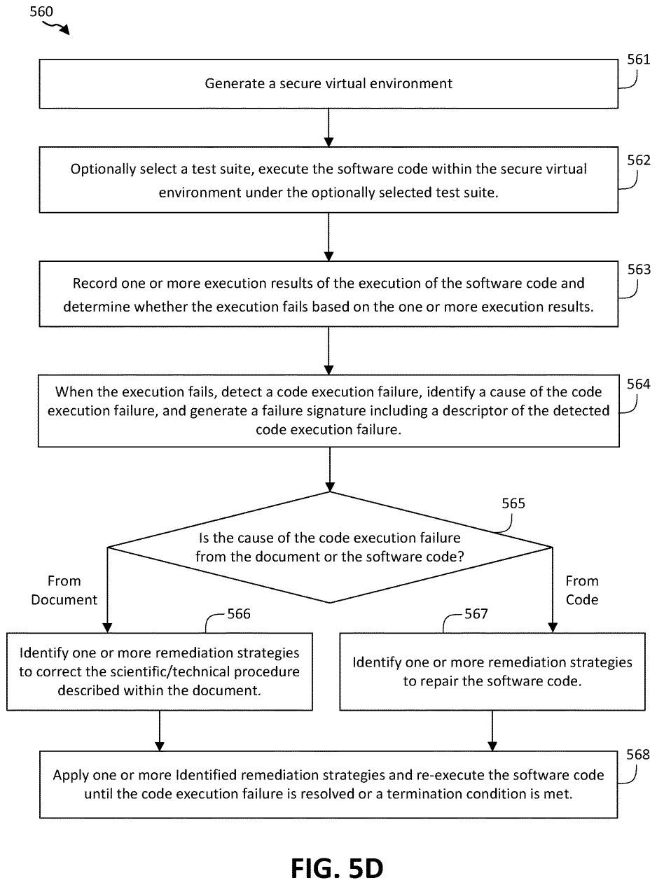

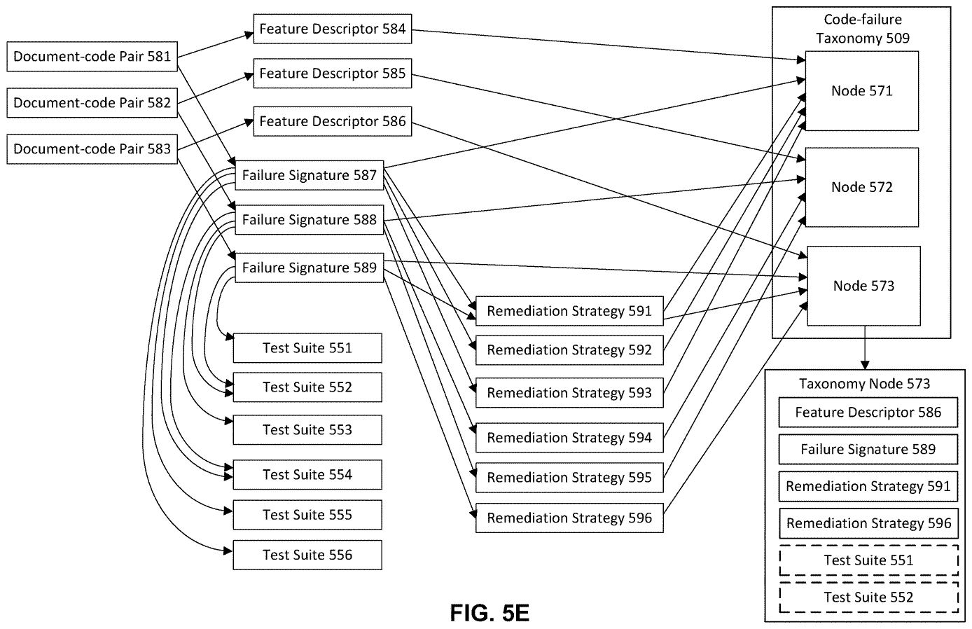

FIG. 5A is a block diagram illustrating a taxonomy generation system 501 for generating a code-failure taxonomy for remediating failures in executing software code according to an aspect of the disclosure. The taxonomy generation system 501 may be a software installed on or accessed (e.g., via a virtual machine, a container, or a web application) on a computing device 504, or may be implemented as a hardware (e.g., processing circuitry) of the computing device 504.

The taxonomy generation system 501 may be coupled to a cloud environment 505, a research paper database 506, a software library database 507, and/or a machine learning (ML) model database 508.

In an aspect, one or more of the databases 506/507/508 may be hosted on the computing device 504 or a different computing device, or in the cloud environment 505.

In an aspect, the research paper database 506 may store a plurality of scientific or technical documents, the software library database 507 may store a plurality of software code associated with the documents stored in the research paper database 506, and the ML model database 508 may store a plurality of machine learning models used to analysis the documents stored in the research paper databased 506 and the software code stored in the software library database 507.

The taxonomy generation system 501 may include a feature extraction module 510, a failure detection module 520, a remediation discovery module 530, a taxonomy construction module 540, and a coverage management module 550.

The taxonomy generation system 501 may execute the feature extraction module 510 to obtain a plurality of scientific or technical documents 502 and a plurality of software code 503 each associated with a respective document 502. Each document 502 may describe one or more scientific or technical computational procedures, and the associated software code 503 may be configured to programmatically implement the one or more scientific or technical computational procedures.

For example, one scientific document 502 may describe a scientific or technical computational procedure for performing an FFT (Fast Fourier Transform) algorithm on a dataset, and the associated software code 503 may include executable instructions (or source code) that receive the dataset as an input, apply the FFT algorithm to the dataset, and output a frequency-domain component of the dataset. In this example, the software code 503 serves as a machine-readable implementation of the computational procedure described within the document 502.

The feature extraction module 510 may treat each document 502 and associated software code 503 as a document-pair project (or a document-code pair). For each project, the feature extraction module 510 may analyze the document 502 and the associated software code 503 using one or more machine learning models (such as large language model) to generate a feature descriptor (or a project feature description) representing a combination of scientific or technical features of the document 502 and code features of the software code 503.

FIG. 5B shows an example of the feature extraction module 510 according to an aspect of the disclosure. As shown in FIG. 5B, the feature extraction module 510 may include a paper analysis machine learning model (MLM) 511 and a software analysis MLM 512.

The paper analysis MLM 511, which may implement an LLM, may be configured to perform semantic analysis of the document 502 to identify one or more scientific or technical features 513 of the document 502. The scientific or technical features 513 may include a scientific or technical domain (e.g., a subject matter or a specific technology field) of the document 502, or describe a scientific methodology. The scientific or technical features 513 may also include scientific or technical computational procedure described within the document 502, such as computational algorithms, scientific procedures, data structures containing scientific or technical datasets, mathematical formulas, chemical formulas, and/or a parameter/quantity (e.g., simulation timestep, simulation duration, or training samples) of the computational procedure. The parameter/quantity may include physical constants used in experiments (e.g., quantities of molecules), starting points for approximation/optimization methods (e.g., differential equation approximation, optimization methods), and parameters of statistical models.

The software analysis MLM 512, which may implement an LLM that is different from or the same as the LLM used in the paper analysis MLM 511, may be configured to perform code analysis of the software code 503 to identify one or more code features 514 of the software code 503 corresponding to the scientific or technical computational procedure described within the document 502. For example, the one or more code features 514 may include a programming language (C++, Java, Python, etc.), a framework (e.g., Django, TensorFlow, PyTorch, etc.), a programming logic or an algorithm, a parameter or a variable of the computational procedure, a configuration option (e.g., environment variables, configuration file format, configuration settings, library, library version, library configuration compiler), or an environment requirement (e.g., operating system or hardware requirement) of the software code 503.

In FIG. 5B, the MLMs 511 and 512 may be two separate models. For example, the MLM 511 may be a natural-language (NL) model configured to produce embeddings for textual procedure steps (e.g., algorithms, equations, parameter statements) of the scientific or technical computational procedures described within the document 502. The MLM 512 may be a programming-language (PL) model configured to produce embeddings for code regions (e.g., functions, file paths, code comments) in the software code 503. These embeddings are mapped into a shared space or cross-attended so that a textual procedure step can align to a specific code region that implements the textual procedure step.

However, in some instances, using two separate models may weaken cross-references between the textual procedure steps described within the document 502 and the implementing code regions in the software code 503. In alternative aspect, a single multi-modal large language model (LLM) may perform an effective cross-references between the textual procedure steps and the implementing code regions.

FIG. 5C shows an example of the feature extraction module 510 including a multi-modal LLM 516 according to an aspect of the disclosure. As shown in FIG. 5C, the multi-modal LLM 516 may extract the scientific or technical features 513 and the code features 514 from the document 502 and the software code 503, respectively. Example approaches of using the multi-modal LLM 516 to map the software code to the scientific or technical computational procedures are described as follows.

### Approach I: Unified Large-Context Alignment (Semantic Mapping)

In this approach, the multi-modal LLM 516 may be a large-context multi-modal language model that is prompted with both document sections (e.g., methodology, algorithm descriptions, equations) of the document 502 and the corresponding code scripts or execution files of the software code 503. The multi-modal LLM 516 may be instructed to perform a step-wise alignment between textual procedure steps described within the document sections and code elements (e.g., functions, classes, and parameter initializations) in the corresponding code scripts or execution files. The multi-modal LLM 516 may be trained on both scientific or technical text (including equations and pseudocode) and source code/executable instructions, and its cross-attention mechanism may align textual procedure steps described within the scientific or technical text to code elements of the source code/executable instructions.

This approach may be used in high-level conceptual mapping, detection of missing or extra steps (e.g., a normalization stage referenced in the document but omitted in the code), and consistency checks between mathematical notation (e.g., variables, constraints) and code-level assignments or function arguments.

### Approach II: Joint Embedding for Retrieval (Vector Similarity Mapping)

When a combined set of document paragraphs and code regions for a document-code pair exceeds a single context window, the multi-modal LLM 516 may invoke a joint NL-PL embedding model (e.g., a contrastive encoder) that projects those document paragraphs and code regions into a shared vector space, enabling large-scale similarity search to retrieve the most relevant code regions for each textual procedure step (and vice versa).

In this approach, the paragraphs of the document 502 and the code regions of the software code 503 are encoded as vectors. A similarity search (e.g., cosine similarity or Euclidean distance) may be used to retrieve the most relevant code regions for each textual procedure step.

This approach may be used in fast retrieval and routing (e.g., establishing candidate code locations for each textual description prior to deeper analysis), creating a ranked shortlist of files/functions to examine, and bootstrapping links when software repositories are large or modular.

### Approach III: Neuro-Symbolic Verification (Structural Consistency Checking)

To ensure that the code logic of the software code 503 matches the scientific or technical computational procedures, the multi-modal LLM 516 may combine ML-based alignment together with static and symbolic program analysis. For example, the multi-modal LLM 516 may extract procedural elements (e.g., equations, objective functions, invariants, parameter ranges, and sequencing constraints) of the scientific or technical computational procedures from the document 502. The multi-modal LLM 516, together with the static and symbolic program analysis, may construct program representations (e.g., abstract syntax trees, control-flow graphs, data-flow graphs, and call graphs) for code regions that implement the procedural elements. The multi-modal LLM 516 may then map extracted procedural elements to the constructed program representations, verifying required order (e.g., matrix multiplication preceding a specified nonlinearity), data flow, and boundary constraints of the scientific or technical computational procedures.

The required order may be verified to ensure that the operation ordering in the software code 503 conforms to the ordering required by the scientific or technical computational procedures. For example, if the scientific or technical computational procedures require to perform a normalization before a linearization, the verification checks whether the software code 503 executes the normalization before the linearization, and flags any deviation (e.g., linearization before normalization).

The data flow is verified to ensure that the transmission and dependency relationships of data between each step are correct. For example, matrix A is multiplied by matrix B in the prescribed direction, features are normalized before they enter the model.

The boundary constraints are verified to ensure that the boundary constraints in the software code 503 satisfy the boundary constraints specified in the document 502.

This approach may be used in rigorous conformance checks where mathematical integrity is paramount and probabilistic alignment alone is insufficient, and elimination of false positives by requiring structural and semantic agreement.

In an aspect, the feature extraction module 510 may combine the above approaches for robustness and scalability. For example, the feature extraction module 510 may chunk the document into discrete algorithmic steps and extract procedural elements (symbols, parameters, constraints), and use joint NL-PL embeddings to retrieve, for each procedural element, the top-k candidate code regions most likely to implement that the respective procedural element. Within each retrieved pair (procedural element and candidate code region), the feature extraction module 510 may apply a large-context alignment for fine-grained mapping, followed by a neuro-symbolic verification to verify required ordering, data-flow/control-flow consistency, and boundary constraints. The feature extraction module 510 may output linked pairs with confidence scores and flags deviations for remediation or review.

Table I provides various examples of scientific or technical features and code features.

TABLE I
Examples of scientific or technical features and code features

| Feature | | |
|---|---|---|
| Source | Feature Category | Extracted Value |
| Document | Scientific Domain | Natural Language Processing, Sentiment Analysis |
| Document | Algorithms | BERT Fine-tuning, Softmax Classification |
| Document | Parameters | Dataset: IMDb Movie Reviews; |
| | | Accuracy Reported: 0.93; |
| | | Training Samples: 25000 |
| Code | Programming Language | Python 3.9 |
| Code | Frameworks/Libraries | Transformers 4.21, PyTorch 1.12 |
| Code | Environment Requirements | Operating System: Ubuntu 22.04; |
| | | Hardware: NVIDIA A100 GPU, CUDA 11.7; |
| | | Memory: 32 GB RAM, 40 GB GPU memory |
| Code | Configuration Options | Config Format: JSON; |
| | | Key Settings: Learning Rate, Batch Size, Max |
| | | Sequence Length, Number of Epochs |

The feature extraction module 510 may combine the one or more scientific or technical features 513 and the one or more code features 514 into a feature descriptor 515.

In an aspect, the feature descriptor 515 may be a vector embedding representing a combination of the scientific or technical features 513 and the code features 514. The feature extraction module 510 may encode the scientific or technical feature 513 and the code feature 514 into numerical vectors by their respective MLMs, and then concatenate or fuse (e.g., through a learned projection layer) the numerical vectors into a single combined vector embedding as the feature descriptor 515.

In an aspect, the feature descriptor 515 may be a data format (e.g., a JSON-like object) with predefined fields (e.g., domain, algorithm, programming language, library, hardware, etc.) representing the features extracted from both the document 502 and the associated software code 503.

Table II provides an example of the feature descriptor 515 in JSON (JavaScript Object Notation) format.

TABLE II
Example of a feature descriptor in JSON format

```
{
  “project_id”: “PRJ-001”,
  “document_features”: {
    “scientific_domain”: [“Natural Language Processing”, “Sentiment Analysis”],
    “algorithms”: [“BERT fine-tuning”, “softmax classification”],
    “parameters”: {
      “dataset”: “IMDb Movie Reviews”,
      “accuracy_reported”: 0.93,
      “training_samples”: 25000
    }
  },
  “code_features”: {
    “programming_language”: “Python 3.9”,
    “frameworks”: [“Transformers 4.21”, “PyTorch 1.12”],
    “environment_requirements”: {
      “operating_system”: “Ubuntu 22.04”,
      “hardware”: “NVIDIA A100 GPU, CUDA 11.7”,
      “memory”: “32 GB RAM, 40 GB GPU memory”
    },
    “configuration”: {
      “config_format”: “JSON”,
      “key_settings”: [“learning_rate”, “batch_size”, “max_seq_length”, “num_epochs”]
    }
  },
}
```

Referring to FIG. 5A, the taxonomy generation system 501 may execute the failure detection module 520 to detect an execution failure of executing the software code 503, and execute the remediation discovery module 530 to identify one or more remediation strategies for the execution failure.

FIG. 5D shows a flowchart of a method 560 for detecting an execution failure of executing software code and resolving the execution failure. The method 560 may be performed by the failure detection module 520 and the remediation discovery module 530.

At 561, for each document-code pair, the failure detection module 520 may generate a secure virtual environment (e.g., a virtual machine, a container, or a sandbox). The secure virtual environment may provide an isolated, self-contained computing environment that is separated from a host system and designed to execute the software code 503 safely without risking damage to or interference from the host system, so that the software code 503 can be tested and repaired in a controlled, reproducible setting.

At 562, the failure detection module 520 may optionally select a test suite, and execute the software code 503 within the secure virtual environment under the optionally selected test suite. The test suite may be a collection of individual tests that are designed to verify whether the software code 503 executes correctly.

In an aspect, the test suite may be a generic test suite, such as an import test configured to check whether all required libraries and modules can be loaded without errors, or a minimal run test configured to check whether the software code 503 can start and execute its entry point without immediately crashing.

In an aspect, the test suite may be a project-specific test suite, such as an output validation test configured to check whether the software code 503 produces outputs that match or approximate results described in the document 502. A project-specific output validation test configures the secure virtual environment and the software code 503 to match the conditions (e.g., dataset split, preprocessing/normalization, model or algorithm parameters, hardware requirements) described within the document 502, runs an evaluation, and computes the same metrics or produces the same results reported in the document 502 (e.g., accuracy, error, runtime). The project-specific test suite then compares the observed outputs to the results reported in the document 502 within predefined tolerances (e.g., absolute or relative thresholds, confidence intervals, or statistical bounds) and declares pass or fail accordingly.

For example, in a machine learning setting, the project-specific test suite may: (i) fix the random seed and load the test split and checkpoint described within the document 502; (ii) enforce the input size and normalization described within the document 502; (iii) run evaluation to compute AUC (Area Under the ROC Curve) and accuracy; and (iv) pass if both metrics meet or exceed the reported values within a small tolerance (e.g., AUC within +0.01, accuracy within 0.02 absolute). In a numerical simulation, the project-specific test suite may: (i) configure grid size, time step, precision, and boundary conditions as specified; (ii) run the solver to the target time; (iii) compute the L2 error against the reference solution described within the document 502 and verify a qualitative invariant (e.g., monotonic energy decay); and (iv) pass if the L2 error is at or below the reported value (within tolerance) and the invariant holds.

In an aspect, the test suite may include reproducibility checks (e.g., repeat runs with identical seeds must produce metrics within a tight delta) and sanity checks on output shapes/formats to ensure the validated results are produced in the expected structure.

In an aspect, the test suite may include at least one of an environment test configured to verify a software dependency in the secure virtual environment or a code execution test configured to execute a portion of the software code with a test dataset.

At 563, the failure detection module 520 may record one or more execution results of the execution of the software code 503 and determine whether the execution fails based on the one or more execution results. The one or more execution results may include an execution log, an error message, a stack trace, and/or an output mismatch indicating a discrepancy with one or more of the computational procedures described within the document 502. The failure detection module 520 may determine that the execution fails when the execution of the software code 503 crashes or when the software code runs without errors but produces incorrect results. For example, when the output of the software code 503 does not match the results or data provided in the document 502, the failure detection module 520 may determine that the execution fails.

At 564, when the execution fails, the failure detection module 520 may detect a code execution failure, identify a cause of the code execution failure, and generate a failure signature including a descriptor of the detected code execution failure. The failure signature may be a normalized, structured representation of key characteristics of the detected code execution failure. For example, the failure signature may be a normalized representation of an error message, a stack trace, and/or an output mismatch in the code execution failure. By extracting the one or more execution results into a consistent format that can be stored in the code-failure taxonomy 509, the failure signature can be compared against other failures and used to match new failures to known remediation strategies.

Table Ill shows an example of a raw execution output and Table IV shows an example of a failure signature extracted from the raw execution output. The raw execution output indicates a missing dependency. It is noted that the specific module name (scipy), the file path (/home/researcher/project/main.py), and the line number (line 5) in the raw execution output are all stripped away during extraction and normalization. What remains is the structural pattern:

a Python import statement fails because a pip-installable package is missing from the environment.

TABLE III
Example of a raw execution output

Traceback (most recent call last):
File “/home/researcher/project/main.py”, line 5, in <module>
import scipy.optimize
ModuleNotFoundError: No module named ‘scipy’

TABLE IV
Example of a failure signature in JSON format

```
{
  “signature_id”: “FS-0042”,
  “failure_source”: “External Environment”,
  “failure_type”: “Functional”,
  “failure_mode”: “Dependency Error”,
  “error_type”: “ModuleNotFoundError”,
  “error_pattern”: “No module named ‘<MODULE>’”,
  “trigger”: “import statement at top-level script”,
  “environment_context”: {
    “language”: “Python”,
    “component”: “pip package”
  },
  “output_mismatch”: null,
  “severity”: “fatal”
}
```

At 565, for each code execution failure, the failure detection module 520 may determine whether the cause of the code execution failure is from the document 502 or the software code 503. If the cause is from the document 502, for example, an incorrect parameter is used or a typographical error (e.g., It is set to be 34.4 instead of 3.14) appears in the scientific or technical computational procedure described within the document 502, the remediation discover module 530 may identify one or more remediation strategies to correct the scientific or technical computational procedure. If the cause is from the software code 503, for example, a wrong software version is used or a code block of the software code 503 is not executable, the remediation discovery module 530 may identify one or more remediation strategies to repair the software code 503.

At 566, the remediation discovery module 530 may identify one or more remediation strategies to correct the scientific or technical computational procedure described within the document 502. Examples include fixing constants, units, or hyperparameters (e.g., It value, learning rate, batch size), correcting equations or boundary/initial conditions, restoring the correct algorithmic order, and/or clarifying data splits and preprocessing steps.

At 567, the remediation discovery module 530 may identify one or more remediation strategies to repair the software code. Each strategy may include an environment-level modification and/or a code-level modification to the software code 503.

In an aspect, the environment-level modification may modify the secure virtual environment in which the software code 503 is executed. For example, the environment-level modification may include a modification to at least one of a software dependency, a software library version, an environment variable, or a hardware allocation.

In an aspect, the code-level modification may modify the software code 503 itself, rather than the secure virtual environment. For example, the code-level modification may include at least one of an application of a predefined path template or a change of the software code 503 using an MLM.

In an aspect, a patch template may be a pre-written, reusable code modification pattern that addresses a known class of errors. For example, when a library has renamed or restructured a function between versions, an API (Application Programming Interface) migration path may be applied; when the software code 503 uses a deprecated argument or method, a deprecation fix patch may be applied; and when the software code 503 fails due to character encoding issues, an encoding fix patch may be applied.

In an aspect, when no predefined patch template exists for the code execution failure, or when the code execution failure requires a more nuanced or context-dependent fix, the remediation discovery module 530 may use an MLM (e.g., a transformer or a code-focused LLM) to generate code modifications. The MLM may be trained to take a failure signature as input and output a patch that is consistent with the document and passes the test suite. By taking into account both the code execution failure and the scientific document, the MLM may produce code changes that are not only syntactically correct but also scientifically consistent.

One key advantage of using an MLM for code-level modifications is flexibility. While patch templates handle well-known, recurring failure patterns efficiently, an MLM can address novel or complex failures that require understanding the scientific context of the software code.

At 568, after identifying the one or more remediation strategies for each code execution failure, the remediation discovery module 530 may perform an iterative remediation process. The remediation discovery module 530 may apply one or more identified remediation strategies and re-execute the software code until the code execution failure is resolved or a termination condition is met. The one or more identified remediation strategies include the one or more remediation strategies to correct the scientific or technical computational procedures and/or the one or more remediation strategies to repair the software code 503.

In an aspect, the remediation discovery module 530 may select one strategy from the one or more identified remediation strategies. The order of selection may be based on factors such as the historical success rate of the strategy for similar failure signatures, the simplicity of the modification, or the confidence level assigned by the MLM that proposed the selected strategy. The remediation discovery module 530 may apply the selected strategy to implement an environment-level modification (such as installing a missing library), a code-level modification (such as applying a patch template), or both. The remediation discovery module 530 may re-execute the (modified) software code 503 in the (modified) secure virtual environment under the same test suite that originally detected the failure. The remediation discovery module 530 may record whether the code execution failure is resolved or improved.

When the selected strategy successfully resolves the code execution failure, the pairing of the failure signature and the successful remediation strategy is stored in the corresponding taxonomy node (or failure classification node) of the code-failure taxonomy 509, so that future projects encountering the same failure pattern can benefit from the proven solution without repeating the trial-and-error process.

When the selected strategy improves but does not fully resolve the code execution failure, the failure detection module 520 may extract a new failure signature from the updated execution results and the remediation discovery module 530 may continue the process by selecting and applying additional strategies until the code executes successfully or a termination condition is met. A termination condition may include a maximum number of remediation attempts, a time limit, or a determination that no remaining strategies are likely to resolve the failure.

In an aspect, the remediation discovery module 530 may apply each remediation strategy and re-execute the software code. Before applying the strategies, the remediation discovery module 530 may rank or prioritize the strategies based on factors such as the historical success rate of each strategy for similar failure signatures, the simplicity of each modification, or the confidence level assigned by the MLM proposing the respective strategy. After each strategy is applied and the software code is re-executed, the remediation discovery module 530 may record the outcome and evaluate it against one or more metrics to determine how effective the strategy is compared to others. The one or more metrics may include a pass/fail status, an error progression, an output quality improvement, and/or an execution depth.

The pass/fail status is the most straightforward metric determining whether the software code passes the test suite. If it does, the strategy is recorded as having fully resolved the failure, and no further strategies need to be applied.

The error progression can be used when a strategy does not fully resolve the failure, and the remediation discovery module 530 examines whether the error has changed. This can be measured by comparing the failure signature before and after the strategy is applied. The error progression can be classified into four levels: (i) original error eliminated with no new error; (ii) original error eliminated with new error appears; (iii) original error persists unchanged; and (iv) original error replaced by a more severe error.

The output quality improvement can be used for failures involving output mismatches rather than hard errors. The remediation discovery module 530 can compare how closely the execution output matches the computational procedure described within the document before and after the strategy is applied.

Table V shows an example of the output quality improvement. In this example, strategy B brings the output much closer to the results reported in the document and may be recorded as the more effective remediation.

TABLE V
An example of output quality improvement

| | Before | After | After |
|---|---|---|---|
| Metric | Remediation | Strategy A | Strategy B |
| Test accuracy | 0.58 (document | 0.74 | 0.91 |
| | reports 0.93) | | |
| Deviation from | 0.35 | 0.19 | 0.02 |
| document | | | |

The execution depth can be used for the remediation discovery module 530 to measure how far into the code's execution pipeline the software code progresses before failing. A strategy that allows the software code to advance further is considered an improvement even if it does not fully resolve the failure.

Table VI shows an example of the execution depth. In this example, strategy B achieves a greater execution depth, indicating it resolved more underlying issues even though the code ultimately still fails.

TABLE VI
An example of execution depth

| | Before | After | After |
|---|---|---|---|
| Metric | Remediation | Strategy A | Strategy B |
| Failure | Line 3 (import | Line 87 (data | Line 204 (model |
| point | statement) | loading) | training) |
| Execution | 2% | 40% | 85% |
| progress | | | |

After all strategies have been applied and evaluated individually, the remediation discovery module 530 may compare their recorded outcomes to select the best one.

In an aspect, if one or more strategies fully (e.g., all mandatory tests in the test suite pass with 100% of pass rate and all errors are eliminated) or nearly completely (e.g., the mandatory tests pass with 95% of pass rate) resolve the failure, the remediation discovery module 530 may select the one that resolves it with the least invasive modification, minimizing the risk of unintended side effects. If no strategy fully resolves the failure but one or more strategies improve it (e.g., the pass rate of the mandatory tests improves by 80%), the remediation discovery module 530 may select the strategy that achieves the greatest improvement and then apply the strategy as a baseline. The remediation discovery module 530 may then extract a new failure signature from the remaining error and repeat the process with additional strategies. If no strategy produces any improvement, the remediation discovery module 530 may escalate to more aggressive remediation approaches, such as invoking an MLM to generate additional code changes, or it may flag the document-code project for manual review and record the failure as unresolved in the code-failure taxonomy 509.

Referring to FIG. 5A, the taxonomy generation system 501 may execute the taxonomy construction module 540 to construct the code-failure taxonomy 509. The code-failure taxonomy 509 may include a plurality of taxonomy nodes that can be organized into various structures.

FIG. 5E illustrates an example of a code-failure taxonomy according to an aspect of the disclosure.

As shown in FIG. 5E, a plurality of document-code pairs (e.g., document-code pairs 581/582/583) may be analyzed by the taxonomy generation system 501, and corresponding feature descriptors (e.g., feature descriptors 584/585/586) may be respectively extracted. The software code of each document-code pair may be executed by the taxonomy generation system 501 and a corresponding failure signature is obtained when the execution fails. For each failure signature, one or more remediation strategies may be identified. For example, remediation strategies 591/592/593 may be identified for the failure signature 587. Each of the remediation strategies 591/592/593 has successfully resolved the execution failure corresponding to the failure signature 587. Each failure signature also corresponds to one or more test suites that are used during the execution corresponding to the respective failure signature. For example, the failure signature 589 corresponds to the test suites 551 and 552 each being used during the execution corresponding to the failure signature 589.

Constructed by the taxonomy generation system 501, the code-failure taxonomy 509 may include a plurality of taxonomy nodes (e.g., taxonomy nodes 571/572/573). Each taxonomy node (also referred to as failure classification node) stores: (i) one or more feature descriptors each derived from a respective document-code pair; (ii) one or more failure signatures each extracted from a software execution associated with a respective document-pair; (iii) one or more remediation strategies that have successfully resolved the one or more failure signatures stored in the correspond node; and (iv) optionally, one or more predefined test suites used during the software execution and repair. For example, the taxonomy node 573 may store the feature descriptor 586 extracted from the document-pair 583, failure signature 589 extracted from the software execution corresponding to the document-code pair 583, remediation strategies 591 and 596 that have successfully resolved the execution failure corresponding to the failure signature 589, and optionally test suites 551 and 552 that are used during the software execution. In an aspect, the taxonomy generation system 501 may execute the taxonomy construction module 540 to update the code-failure taxonomy 509.

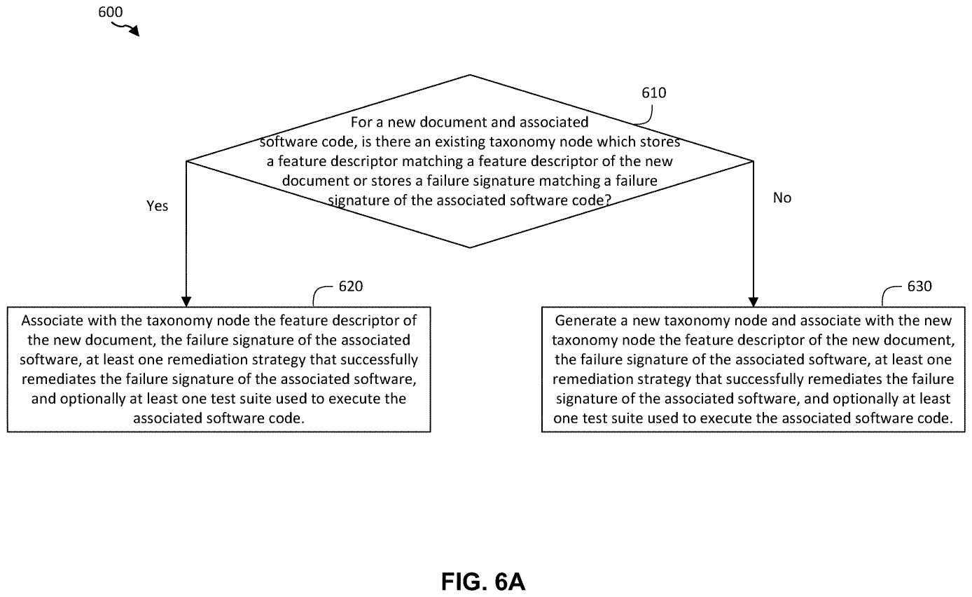

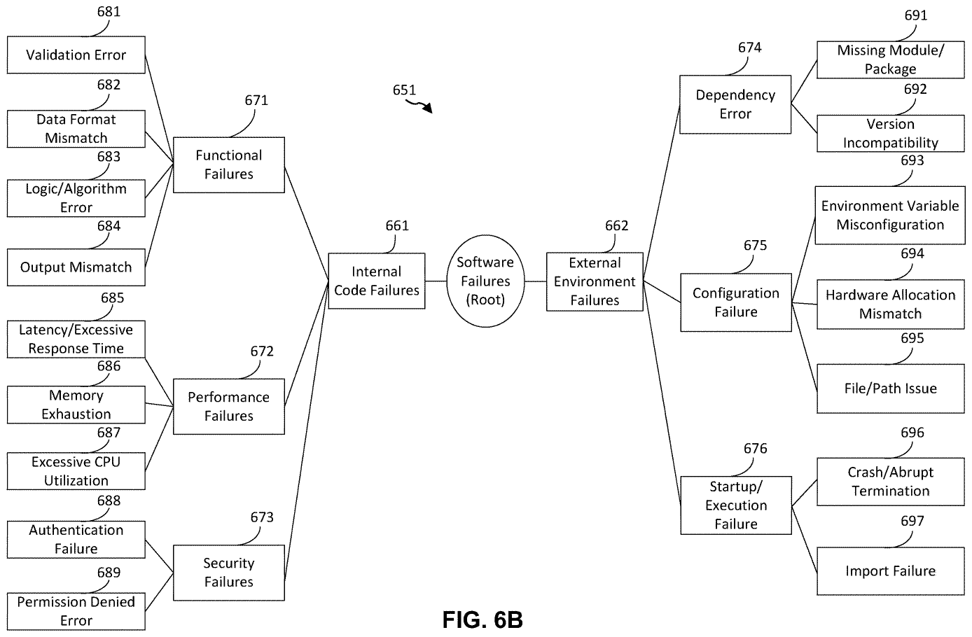

FIG. 6A shows a flowchart of a method 600 for updating the code-failure taxonomy according to an aspect of the disclosure. The method 600 may be performed by the taxonomy construction module 540.

At 610, for a new document and associated software code, the taxonomy construction module 540 may determine whether there is an existing taxonomy node in the code-failure taxonomy. The existing taxonomy node stores a feature descriptor matching a feature descriptor of the new document or stores a failure signature matching a failure signature of the associated software code.

At 620, when it is determined that there is such an existing taxonomy node, the taxonomy construction module 540 may associate with the existing taxonomy node the feature descriptor of the new document, the failure signature of the associated software code, at least one remediation strategy that successfully remediates the failure signature of the associated software code, and optionally at least one test suite used to execute the associated software code.

At 630, when it is determined that there is no such existing taxonomy node, the taxonomy construction module 540 may generate a taxonomy node in the code-failure taxonomy and associate with the new taxonomy node the feature descriptor of the new document, the failure signature of the associated software code, at least one remediation strategy that successfully remediates the failure signature of the associated software code, and optionally at least one test suite used to execute the associated software code.

Referring to FIG. 5A, the taxonomy generation system 501 may execute the coverage management module 550 to maintain coverage information for the code-failure taxonomy 509. The coverage information may include, for each taxonomy node, first information indicating whether at least one representative document-code project has been associated with the respective taxonomy node, second information indicating whether at least one code execution failure associated with the respective taxonomy node has been observed and resolved, and third information indicating whether at least one predefined test suite associated with the respective taxonomy node has been executed successfully after remediation. The coverage management module 550 may use the coverage information to identify under-represented or untested regions of the code-failure taxonomy 509, where the associated remediation strategies and/or test suites are unverified.

In an aspect, the code-failure taxonomy 509 may comprise a multi-level hierarchical structure, wherein each level represents a different granularity of code execution failure.

FIG. 6B illustrates an example taxonomy tree data structure 651 for a multi-level hierarchical implementation of the code-failure taxonomy 509, according to an aspect of the disclosure. As shown, the taxonomy tree 651 provides a classification of software failures for scientific or technical code execution, organizing the failures into multiple levels of increasing granularity. In other aspects, the taxonomy may utilize alternative data structures, such as a directed acyclic graph (DAG), a multi-dimensional matrix, or an ontology.

At a first level, the taxonomy tree 651 may represent a failure source of a code execution failure. The failure source may indicate whether the code execution failure originates from within the software code itself (e.g., internal code failure 661) or from the secure virtual environment (e.g., external environment failure 662). This first level may separate failures that require code-level modifications from those that require environment-level modifications.

At a second level, the taxonomy tree 651 may represent a failure type of a code execution failure. Under internal code failures 661, examples of failure types may include: (i) functional failures 671, in which the software code does not produce correct results or cannot execute its intended logic; (ii) performance failures 672, in which the software code executes but does not meet expected performance characteristics such as resource consumption or timing requirements; and (iii) security failures 673, in which the software code encounters permission, authentication, or access control issues. Under external environment failures 662, examples of failure types may include: (i) dependency errors 674, in which a required software dependency is missing or incompatible; (ii) configuration failures 675, in which environment variables, settings, or resource allocations are incorrect; and (iii) startup/execution failures 676, in which the code cannot start or complete execution in the environment.

At a third level, the taxonomy tree 651 may represent a failure mode of a code execution failure, which further refines the failure type into a specific category. For example, under the functional failure type 671, examples of failure modes may include a validation error 681, a data format mismatch 682, a logic/algorithm error 683, or an output mismatch 684 indicating a discrepancy between code output and results reported in the associated document. Under the performance failure type 672, examples of failure modes may include latency or excessive response time 685, memory exhaustion 686, or excessive CPU utilization 687. Under the security failure type 673, examples of failure modes may include an authentication failure 688 or a permission denied error 689. Under the dependency error type 674, examples of failure modes may include a missing module or package 691, or a version incompatibility 692 such as a library version conflict or deprecated API. Under the configuration failure type 675, examples of failure modes may include an environment variable misconfiguration 693, a hardware allocation mismatch 694, or a file/path issue 695. Under the startup/execution failure type 676, examples of failure modes may include a crash or abrupt termination 696, or an import failure 697.

At each level, each taxonomy node (also referred to as failure classification node) of the taxonomy tree 651 may store: (i) one or more feature descriptors each derived from a respective document-code pair; (ii) one or more failure signatures each extracted from a software execution associated with a respective document-pair; (iii) one or more remediation strategies that have successfully resolved the one or more failure signatures stored in the correspond node; and (iv) optionally, one or more predefined test suites used during the software execution and repair.

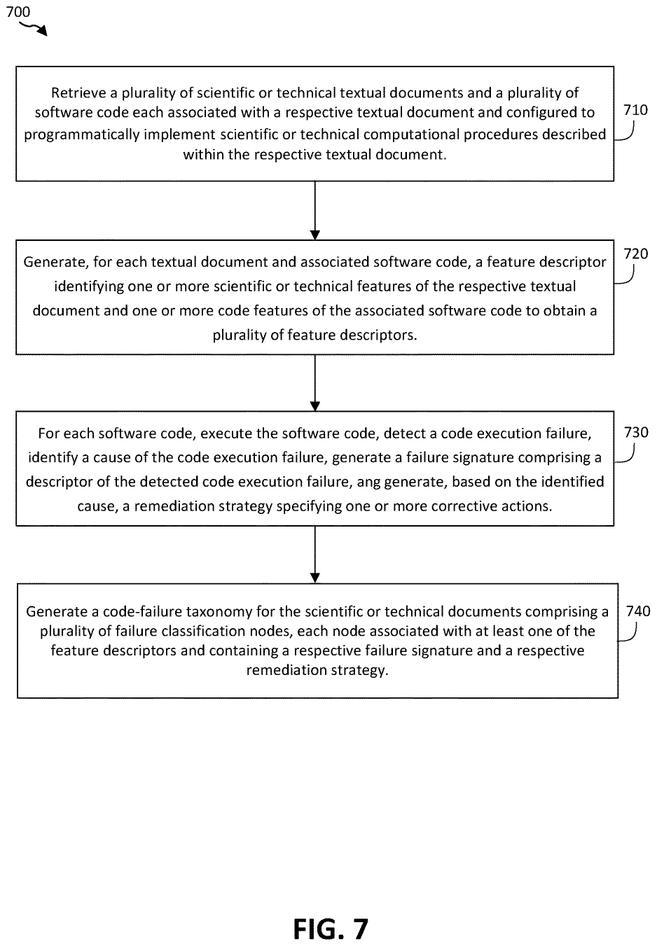

FIG. 7 shows a flowchart of a method 700 according to an aspect of the disclosure. The method 700 may be performed by the taxonomy generation system 501 for generating a code-failure taxonomy (e.g., the code-failure taxonomy 509) for remediating failures in executing software code.

At 710, the taxonomy generation system 501 may retrieve a plurality of scientific or technical textual document and a plurality of software code each associated with a respective textual document and configured to programmatically implement scientific or technical computational procedures described within the respective textual document.

At 720, the taxonomy generation system 501 may generate, for each textual document and associated software code, a feature descriptor identifying one or more scientific or technical features of a respective textual document and one or more code features of the associated software code to obtain a plurality of feature descriptors.

In an aspect, the taxonomy generation system 501 may use a trained machine learning model (MLM) to identify the one or more scientific or technical features of the textual document corresponding to the scientific or technical computational procedures described within the textual document, use the trained MLM to identify in the software code the one or more code features corresponding to the identified one or more scientific or technical features of the textual document, and generate at least one of the feature descriptors combining the one or more scientific or technical features and corresponding code features.

In an aspect, the one or more scientific or technical features of the textual document may include at least one of a scientific or technical domain of the textual document, a computational algorithm, a scientific procedure, a mathematical formula, a chemical formula, or a data structure containing scientific or technical data.

In an aspect, the one or more code features of the software code may include at least one of a programming language of the software code, an algorithm of the software code, a parameter or a variable of the software code, a configuration option of the software code, or an environment requirement of the software code.

At 730, for each software code, the taxonomy generation system 501 may execute the software code, detect a code execution failure, identify a cause of the code execution failure, generate a failure signature comprising a descriptor of the detected code execution failure, and generate, based on the identified cause, a remediation strategy specifying one or more corrective actions.

In an aspect, the code execution failure may include at least one of log data, an error message, a stack trace, or an output mismatch indicating a discrepancy with one or more of the computational procedures described within the textual document.

In an aspect, the taxonomy generation system 501 may generate a secure virtual environment and execute the software code within the secure virtual environment.

In an aspect, the taxonomy generation system 501 may execute the software code within the secure virtual environment under a test suite. The test suite may include at least one of an environment test configured to verify a software dependency in the secure virtual environment or a code execution test configured to execute a portion of the software code with a test dataset.

In an aspect, the test suite may be associated with one failure classification node corresponding to the code execution failure of the software code.

In an aspect, the failure signature may be based on a normalized representation of the at least one of the log data, the error message, the stack trace, or the output mismatch included in the code execution failure.

In an aspect, the remediation strategy may include at least one of an environment-level modification or a code-level modification to the software code.

In an aspect, the environment-level modification may include a modification to at least one of a software dependency, a library version, an environment variable, or a hardware allocation.

In an aspect, the code-level modification may include at least one of an application of a predefined path template or a change of the software code using an MLM.

At 740, the taxonomy generation system 501 may generate a code-failure taxonomy (e.g., the code-failure taxonomy 509) for scientific or technical documents including a plurality of failure classification nodes, each node associated with at least one of the feature descriptors and containing a respective failure signature and a respective remediation strategy.

In an aspect, each of at least a subset of the failure classification nodes of the code-failure taxonomy may be associated with at least one test suite used during execution of the software code corresponding to the failure signature associated with the respective node. The at least one test suite may include at least one of an environment test configured to verify a software dependency in a secure virtual environment or a code execution test configured to execute a portion of the software code with a test dataset.

In an aspect, the taxonomy generation system 501 may repair the software code based on the one or more corrective actions specified in the remediation strategy and re-execute the repaired software code until the failure signature is remediated or a termination condition is met. A termination condition may include a maximum number of remediation attempts, a time limit, or a determination that no remaining strategies are likely to resolve the failure.

In an aspect, the taxonomy generation system 501 may update the code-failure taxonomy by determining whether a feature descriptor of a new textual document matches the feature descriptors already associated with the nodes of the code-failure taxonomy or an extracted failure signature of a new software code matches the failure signatures already associated with the nodes of the code-failure taxonomy. The new software code is associated with the new textual document, and the extracted failure signature is extracted from execution of the new software code.

In an aspect, in response to the feature descriptor matching the feature descriptors already associated with the nodes of the code-failure taxonomy or the extracted failure signature matching the failure signatures already associated with the nodes of the code-failure taxonomy, the taxonomy generation system 501 may associate with the node having the matched feature descriptor or the matched failure signature the feature descriptor, the extracted failure signature, and at least one remediation strategy that successfully remediates the extracted failure signature. In response to the feature descriptor not matching the feature descriptors already associated with the nodes of the code-failure taxonomy and the extracted failure signature not matching the failure signatures already associated with the failure classification nodes of the code-failure taxonomy, the taxonomy generation system 501 may generate a new failure classification node of the code-failure taxonomy. The taxonomy generation system 501 may associate with the new failure classification node the feature descriptor, the extracted failure signature, and the at least one remediation strategy that successfully remediates the extracted failure signature.

In an aspect, a hierarchical structure of the code-failure taxonomy includes a multi-level taxonomy tree with each level representing a failure granularity of the code execution failure.

In an aspect, the taxonomy tree may include three levels of failure granularity. A first level of failure granularity identifies a failure source of the code execution failure, a second level of failure granularity identifies a failure type of the code execution failure, and a third level of failure granularity identifies a failure mode of the code execution failure.

In an aspect, the failure source may include at least one of an internal code failure source or a computing environment failure source. The failure type may include at least one of a functional failure type, a performance failure type, or a security failure type. The failure mode may include at least one of a validation failure mode, a latency failure mode, or an auth failure mode.

After the code-failure taxonomy 509 is reconstructed, it can be used to repair software code associated with a new scientific or technical document.

This disclosure provides methods and systems of remediating failures in executing software code associated with a scientific or technical textual document using a pre-built code-failure taxonomy (e.g., the code-failure taxonomy 509).

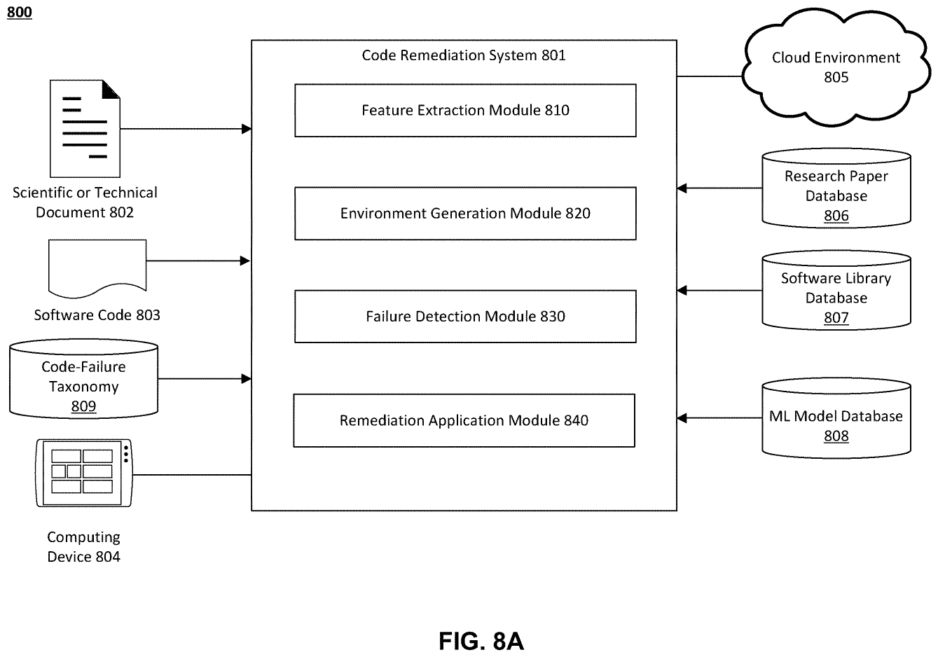

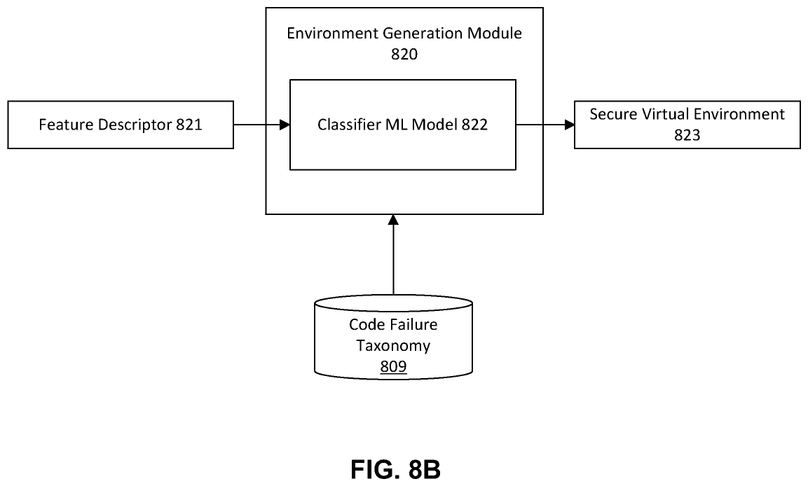

FIG. 8A is a block diagram illustrating a code remediation system 801 for remediating failures in executing software code associated with a scientific or technical textual document using a code-failure taxonomy 809 according to an aspect of the disclosure. The code remediation system 801 may be a software installed on or accessed (e.g., via a virtual machine, a container, or a web application) on a computing device 804, or may be implemented as a hardware (e.g., processing circuitry) of the computing device 804.

The code remediation system 801 may be coupled to a cloud environment 805, a research paper database 806, a software library database 807, and/or a machine learning (ML) model database 808.

In an aspect, one or more of the databases 806/807/808 may be hosted on the computing device 804 or a different computing device, or in the cloud environment 805.

In an aspect, the research paper database 806 may store a plurality of scientific or technical documents, the software library database 807 may store a plurality of software code associated with the documents stored in the research paper database 806, and the ML model database 808 may store a plurality of machine learning models used to analysis the documents stored in the research paper databased 806 and the software code stored in the software library database 807.

The code remediation system 801 may include a feature extraction module 810, an environment generation module 820, a failure detection module 830, and a remediation application module 840. The feature extraction module 810 and the failure detection module 830 are similar to the feature extraction module 510 and the failure detection module 520, respectively, and thus some descriptions are omitted.

The code remediation system 801 may execute the feature extraction module 810 to obtain a scientific or technical documents 802 and associated software code 803. The document 802 may describe one or more computational procedures, and the associated software code 803 may be configured to programmatically implement the one or more computational procedures.

The feature extraction module 810 may treat the document 802 and associated software code 803 as a document-pair project (or a document-code pair), and analyze the document 802 and the associated software code 803 using one or more machine learning models (e.g., a paper analysis MLM and/or a software analysis MLM) to generate a feature descriptor 821 (shown in FIG. 8B) representing a combination of scientific or technical features of the document 802 and code features of the software code 803.

In an aspect, the scientific or technical features of the document 802 may include an algorithm, a data structure, a mathematical formula, and/or a parameter/quantity (e.g., simulation timestep, simulation duration, or training samples) of a computational procedure described within the document 802. The parameter/quantity may include physical constants used in experiments (e.g., quantities of molecules), starting points for approximation/optimization methods (e.g., differential equation approximation, optimization methods), and parameters of statistical models.

In an aspect, the code features of the software code 803 may include a programming language (C++, Java, Python, etc.), a framework (e.g., Django, TensorFlow, PyTorch, etc.), a programming logic or an algorithm, a parameter or a variable of the computational procedure, a configuration option (e.g., environment variables, configuration file format, configuration settings, library, library version, library configuration compiler), or an environment requirement (e.g., operating system or hardware requirement) of the software code 803.

Detailed descriptions of the feature extraction module 810 can be referred to the descriptions of the feature extraction module 510 and FIGS. 5B-5C. The one or more machine learning models in the feature extraction module 810 can be same or compatible with the one or more machine learning models in the feature extraction module 510.

The code remediation system 801 may execute the environment generation module 820 to generate a secure virtual environment, within which the software code 803 is executed.

FIG. 8B shows an example of the environment generation module 820 according to an aspect of the disclosure. The environment generation module 820 may receive the feature descriptor 821 and select one or more taxonomy nodes from a pre-built code-failure taxonomy 809 based on the feature descriptor 821.

In an aspect, the environment generation module 820 may use a classifier MLM 822 (e.g., BERT, GPT-based classifier, SVM, KNN) to select the one or more taxonomy nodes from the pre-built code-failure taxonomy 809. The classifier MLM 822 may be trained to take a feature descriptor (e.g., feature descriptor 821) as input and output a plurality of taxonomy node identifiers, each with an associated confidence score. The environment generation module 820 may select one or more taxonomy node identifiers each with the associated confidence score exceeding a confidence score threshold. The environment generation module 820 may use the one or more taxonomy node identifiers to identify the one or more taxonomy nodes.

In an aspect, the environment generation module 820 may use similarity measures (e.g., cosine similarity or Euclidean distance) to select the one or more taxonomy nodes from the pre-built code-failure taxonomy 809. The environment generation module 820 may compute a similarity score between the feature descriptor 821 and each feature descriptor associated with the taxonomy nodes of the pre-built code-failure taxonomy 809. The environment generation module 820 may select one or more taxonomy nodes each with the similarity score exceeding a similarity score threshold.

From each of the selected one or more taxonomy nodes, the environment generation module 820 may retrieve one or more test suites, known failure signatures and associated proven remediation strategies, and suggested environment requirements associated with the respective taxonomy node. The environment generation module 820 may generate a secure virtual environment 823 based on the retrieved environment requirements (e.g., base OS, key libraries, hardware constraints) and deploy the software code 803 into the secure virtual environment 823. The code remediation system 801 may execute the failure detection module 830 to execute the software code 803 and detect a code execution. The failure detection module 830 may execute the software code 803 within the secure virtual environment 823 under the one or more test suites retrieved by the environment generation module 820. The failure detection module 830 may record execution results of the execution of the software code 803 and detect whether the execution fails based on the execution results. If the execution fails, the failure detection module 830 may extract a failure signature from the execution results.

Detailed descriptions of the failure detection module 830 can be referred to the descriptions of the failure detection module 520.

The code remediation system 801 may execute the remediation application module 840 to repair the software code 803 when a code execution failure is detected. The code remediation system 801 may compare the extracted failure signature of the software code 803 to the known failure signatures associated with the selected taxonomy node(s).

If a matched or sufficiently similar failure signature is found, the remediation application module 840 may select one or more proven remediation strategies corresponding to the found failure signature. Each proven remediation strategy may include environment-level and/or code-level modifications. The remediation application module 840 may apply each proven remediation strategy to the secure virtual environment 823 and/or to the software code 803, re-execute the software code 803 under the same test suite, and determine whether the failure is resolved. If the failure is resolved, the remediation application module 840 may report success and the applied remediation strategy that resolves the failure.

In an aspect, the code remediation system 801 may determine whether a new failure signature is sufficiently similar to a known failure signature based on a field-level comparison between the new failure signature and the known failure signature. The field-level comparison compares individual fields of the failure signatures and determines how many fields match or are closely related. For example, the two failure signatures are sufficiently similar if their important fields match.

If no matched or sufficiently similar failure signature is found, or if none of the one or more corresponding proven remediation strategies resolves the failure, the remediation application module 840 may optionally apply a generic or heuristic remediation strategy, and optionally add the new failure signature and successful remediation strategy, if any, as a new taxonomy node in the code-failure taxonomy 809, and continue to refine the code-failure taxonomy 809.

In an aspect, examples of generic remediation strategies may include environment reset (e.g., by recreating the secure virtual environment from scratch), dependency reconciliation (e.g., by auto-installing missing packages), and/or resource safeguard (e.g., by reducing batch size).

In an aspect, examples of heuristic remediation strategies may include allocating a larger GPU/enabling mixed precision for an accelerator error, applying a targeted API-migration shim/using the most likely version pivot for an API error, reducing a learning rate/adding gradient clipping to denominators/setting random seeds for a result divergence error, and/or falling back to environment variables for a file/path issue.

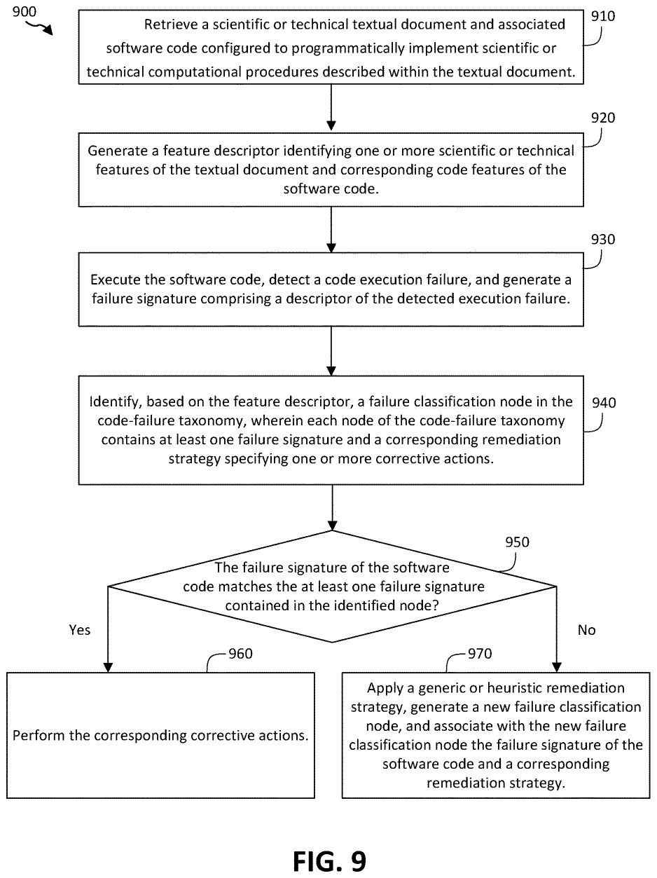

FIG. 9 shows a flowchart of a method 900 according to an aspect of the disclosure. The method 900 may be implemented by the code remediation system 801 for remediating failures in executing software code associated with a scientific or technical textual document using a code-failure taxonomy.

In an aspect, each node of the code-failure taxonomy is associated with at least one environment requirement used during execution of at least one software code, wherein the at least one environment requirement includes at least one of a base operating system, a key library, or a hardware constraint.

In an aspect, each node of the code-failure taxonomy is associated with at least one test suite used during execution of at least one software code, wherein the at least one test suite includes at least one of an environment test configured to verify a software dependency in a secure virtual environment or a code execution test configured to execute a portion of the at least one software code with a test dataset.

At 910, the code remediation system 801 may retrieve a scientific or technical textual document and associated software code configured to programmatically implement scientific or technical computational procedures described within the textual document.

At 920, the code remediation system 801 may generate a feature descriptor identifying one or more scientific or technical features of the textual document and one or more corresponding code features of the software code.

In an aspect, the code remediation system 801 may use a trained machine learning model (MLM) to identify the one or more scientific or technical features of the textual document corresponding to the scientific or technical computational procedures described within the textual document. The code remediation system 801 may use the MLM to identify in the software code one or more code features corresponding to the identified one or more scientific or technical features of the textual document. The code remediation system 801 may generate the feature descriptor combining the one or more scientific or technical features and corresponding code features.

In an aspect, the one or more scientific or technical features of the textual document may include at least one of a scientific or technical domain of the textual document, a computational algorithm, a scientific procedure, a mathematical formular, a chemical formula, or a data structure containing scientific or technical data.

In an aspect, the one or more code features of the software code may include at least one of a programming language of the software code, an algorithm of the software code, a parameter or a variable of the software code, a configuration option of the software code, or a hardware requirement of the software code.

At 930, the code remediation system 801 may execute the software code, detect a code execution failure, and generate a failure signature comprising a descriptor of the detected execution failure.

In an aspect, the code remediation system 801 may generate a secure virtual environment based on an environment requirement associated with the identified failure classification node. The code remediation system 801 may obtain a test suite associated with the identified failure classification node. The code remediation system 801 may execute the software code in the virtual environment under the test suite to obtain the code execution failure.

In an aspect, the code execution failure may include at least one of log data, an error message, a stack trace, or an output mismatch indicating a discrepancy with one or more of the scientific or technical computational procedures described within the textual document.

In an aspect, the failure signature may be based on a normalized representation of the at least one of the log data, the error message, the stack trace, or the output mismatch included in the code execution failure.

At 940, the code remediation system 801 may identify, based on the feature descriptor, a failure classification node in the code-failure taxonomy. Each failure classification node of the code-failure taxonomy contains at least one failure signature and a corresponding remediation strategy specifying one or more corrective actions.

In an aspect, the code remediation system 801 may input the feature descriptor of the textual document into a classifier MLM trained to map a plurality of feature descriptors to a plurality of failure classification nodes of the code failure taxonomy. The code remediation system 801 may receive, from the classifier MLM, one or more node identifiers each associated with a respective confidence value. The code remediation system 801 may identify the failure classification node from one or more failure classification nodes associated with the one or more node identifiers based on the confidence value of the identified failure classification node exceeding a threshold.

In an aspect, the remediation strategy may include at least one of an environment-level modification or a code-level modification to the software code.

In an aspect, the environment-level modification may include a modification to at least one of a software dependency, a library version, an environment variable, or a hardware allocation.

In an aspect, the code-level modification may include at least one of an application of a predefined path template or a change of the software code using an MLM.

At 950, the code remediation system 801 may determine whether the failure signature of the software code matches the at least one failure signature contained in the identified failure classification node.

At 960, in response to the failure signature of the software code matching the at least one failure signature contained in the identified failure classification node, the code remediation system 801 may perform the corresponding corrective actions.

In an aspect, after performing the corresponding corrective actions, the code remediation system 801 may re-execute the software code in the secure virtual environment under the test suite to determine whether the software code executes correctly. In response to the software code executing correctly, the code remediation system 801 may report the corresponding remediation strategy contained in the identified failure classification node. In response to the software code not executing correctly, the code remediation system 801 may apply a generic or heuristic remediation strategy to the software code, generate a new failure classification node, and associate with the new failure classification node the failure signature of the software code and a corresponding remediation strategy.

At 970, in response to the failure signature of the software code not matching the at least one failure signature contained in the identified failure classification node, the code remediation system 801 may apply a generic or heuristic remediation strategy to the software code, generate a new failure classification node, and associate with the new failure classification node the failure signature of the software code and a corresponding remediation strategy.

In an aspect, a hierarchical structure of the code-failure taxonomy may include a multi-level taxonomy tree with each level representing a failure granularity of the code execution failure, and the failure classification nodes are leaf nodes of the taxonomy tree.

In an aspect, the taxonomy tree may include four levels of failure granularity, and wherein a first level of failure granularity identifies a failure source of the code execution failure, a second level of failure granularity identifies a failure type of the code execution failure, a third level of failure granularity identifies a failure mode of the code execution failure, and a fourth level of failure granularity identifies the failure signature extracted from the code execution failure.

In an aspect, the failure source may include at least one of an internal code failure source or an external environment failure source; the failure type includes at least one of a functional failure type, a performance failure type, or a security failure type; and the failure mode includes at least one of a validation failure mode, a latency failure mode, or an auth failure mode.

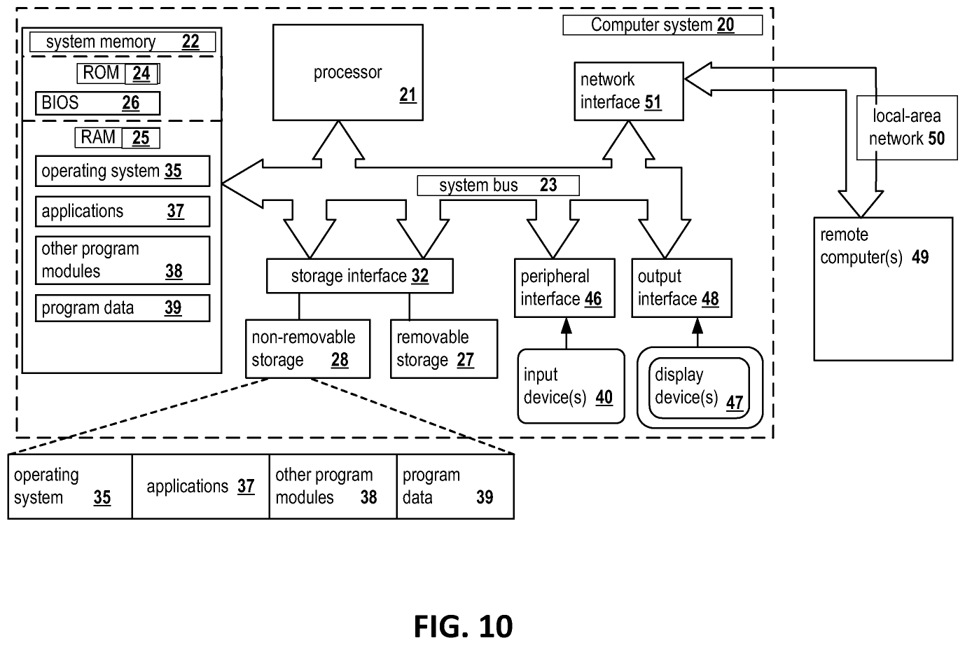

FIG. 10 is a block diagram illustrating a computer system 20 on which aspects of systems (e.g., the systems 501 and 801) and methods (e.g., the methods 700 and 900) described in this disclosure may be implemented. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I2C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-5 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A computer-implemented method for remediating failures in executing software code associated with a scientific or technical document using a code-failure taxonomy, the computer-implemented method comprising:
retrieving a scientific or technical textual document and associated software code configured to programmatically implement scientific or technical computational procedures described within the textual document;
generating a feature descriptor identifying one or more scientific or technical features of the textual document and one or more corresponding code features of the software code;
executing the software code, detecting a code execution failure, and generating a failure signature comprising a descriptor of the detected execution failure;
identifying, based on the feature descriptor, a failure classification node in the code-failure taxonomy, wherein each node of the code-failure taxonomy contains at least one failure signature and a corresponding remediation strategy specifying one or more corrective actions; and
in response to the failure signature of the software code matching the at least one failure signature contained in the identified failure classification node, performing the corresponding corrective actions.

2. The computer-implemented method of claim 1, wherein each node of the code-failure taxonomy is associated with at least one environment requirement used during execution of at least one software code, wherein the at least one environment requirement includes at least one of a base operating system, a key library, or a hardware constraint.

3. The computer-implemented method of claim 1, wherein each node of the code-failure taxonomy is associated with at least one test suite used during execution of at least one software code, wherein the at least one test suite includes at least one of an environment test configured to verify a software dependency in a secure virtual environment or a code execution test configured to execute a portion of the at least one software code with a test dataset.

4. The computer-implemented method of claim 1, wherein the generating the feature descriptor includes:
using a trained machine learning model (MLM) to identify the one or more scientific or technical features of the textual document corresponding to the scientific or technical computational procedures described within the textual document;
using the MLM to identify in the software code the one or more code features corresponding to the identified one or more scientific or technical features of the textual document; and
generating the feature descriptor combining the one or more scientific or technical features and corresponding code features.

5. The computer-implemented method of claim 1, wherein the one or more scientific or technical features of the textual document include at least one of a scientific or technical domain of the textual document, a computational algorithm, a scientific procedure, a mathematical formular, a chemical formula, or a data structure containing scientific or technical data.

6. The computer-implemented method of claim 1, wherein the one or more code features of the software code includes at least one of a programming language of the software code, an algorithm of the software code, a parameter or a variable of the software code, a configuration option of the software code, or a hardware requirement of the software code.

7. The computer-implemented method of claim 1, wherein the identifying the failure classification node includes:
inputting the feature descriptor of the textual document into a classifier MLM trained to map a plurality of feature descriptors to a plurality of failure classification nodes of the code failure taxonomy;
receiving, from the classifier MLM, one or more node identifiers each associated with a respective confidence value; and
identifying the failure classification node from one or more failure classification nodes associated with the one or more node identifiers based on the confidence value of the identified failure classification node exceeding a threshold.

8. The computer-implemented method of claim 1, wherein the executing the software code includes:
generating a secure virtual environment based on an environment requirement associated with the identified failure classification node;
obtaining a test suite associated with the identified failure classification node; and
executing the software code in the secure virtual environment under the test suite to obtain the code execution failure.

9. The computer-implemented method of claim 8, further comprising:
after the performing the corresponding corrective actions,
re-executing the software code in the secure virtual environment under the test suite to determine whether the software code executes correctly; and
in response to the software code executing correctly, reporting the corresponding remediation strategy contained in the identified failure classification node.

10. The computer-implemented method of claim 9, further comprising:
in response to the software code not executing correctly or the failure signature of the software code not matching the at least one failure signature contained in the identified failure classification node,
applying a generic or heuristic remediation strategy to the software code;
generating a new failure classification node of the code-failure taxonomy; and
associating with the new failure classification node the failure signature of the software code and a corresponding remediation strategy.

11. The computer-implemented method of claim 1, wherein the code execution failure includes at least one of log data, an error message, a stack trace, or an output mismatch indicating a discrepancy with one or more of the scientific or technical computational procedures described within the textual document.

12. The computer-implemented method of claim 11, wherein the failure signature is based on a normalized representation of the at least one of the log data, the error message, the stack trace, or the output mismatch included in the code execution failure.

13. The computer-implemented method of claim 1, wherein the remediation strategy includes at least one of an environment-level modification or a code-level modification to the software code.

14. The computer-implemented method of claim 13, wherein the environment-level modification includes a modification to at least one of a software dependency, a library version, an environment variable, or a hardware allocation.

15. The computer-implemented method of claim 13, wherein the code-level modification includes at least one of an application of a predefined path template or a change of the software code using an MLM.

16. The computer-implemented method of claim 1, wherein a hierarchical structure of the code-failure taxonomy includes a multi-level taxonomy tree with each level representing a failure granularity of the code execution failure.

17. A system for remediating failures in executing software code associated with a scientific or technical document using a code-failure taxonomy, the system comprising processing circuitry configured to:
retrieve a scientific or technical textual document and associated software code configured to programmatically implement scientific or technical computational procedures described within the textual document;
generate a feature descriptor identifying one or more scientific or technical features of the textual document and one or more corresponding code features of the software code;
execute the software code, detect a code execution failure, and generate a failure signature comprising a descriptor of the detected execution failure;
identify, based on the feature descriptor, a failure classification node in the code-failure taxonomy, wherein each node of the code-failure taxonomy contains at least one failure signature and a corresponding remediation strategy specifying one or more corrective actions; and
in response to the failure signature of the software code matching the at least one failure signature associated with the identified failure classification node, perform the corresponding corrective actions.

18. The system of claim 17, wherein the one or more scientific or technical features of the textual document include at least one of a scientific or technical domain of the textual document, a computational algorithm, a scientific procedure, a mathematical formular, a chemical formula, or a data structure containing scientific or technical data.

19. The system of claim 17, wherein the one or more code features of the software code include at least one of a programming language of the software code, an algorithm of the software code, a parameter or a variable of the software code, a configuration option of the software code, or an environment requirement of the software code.

20. A non-transitory computer readable medium storing thereon computer executable instructions for remediating failures in executing software code associated with a scientific or technical document using a code-failure taxonomy, including instructions for:
retrieving a scientific or technical textual document and associated software code configured to programmatically implement scientific or technical computational procedures described within the textual document;
generating a feature descriptor identifying one or more scientific or technical features of the textual document and one or more corresponding code features of the software code;
executing the software code, detecting a code execution failure, and generating a failure signature comprising a descriptor of the detected execution failure;
identifying, based on the feature descriptor, a failure classification node in the code-failure taxonomy, wherein each node of the code-failure taxonomy contains at least one failure signature and a corresponding remediation strategy specifying one or more corrective actions; and
in response to the failure signature of the software code matching the at least one failure signature associated with the identified failure classification node, performing the corresponding corrective actions.
